(19) United States
(12) Patent Application Publication
(10) Pub. No.: US 2025/0168081 A1
(43) Pub. Date: May 22, 2025

(54) DISTRIBUTED MACHINE LEARNING MODEL CONFIGURATIONS

(71) Applicant: QUALCOMM INCORPORATED, San Diego, CA (US)

(72) Inventors: Juan Zhang, Beijing (CN); Xipeng Zhu, San Diego, CA (US); Rajeev Kumar, San Diego, CA (US); Shankar Krishnan, Poway, CA (US)

(21) Appl. No.: 18/833,798

(22) PCT Filed: Mar. 31, 2022
(86) PCT No.: PCT/CN2022/084328

§ 371 Date: Jul. 26, 2024

(51) Int. Cl. H04L 41/16; H04W 24/02

(52) U.S. Cl. CPC H04L 41/16; H04W 24/02

(57) ABSTRACT

Methods, systems, and devices for wireless communications are described. A UE may be configured with a machine learning model by a core network to perform analytics, training, or inferences. The UE may exchange capability information with a core network related to machine learning models. For example, the UE may indicate a list of machine learning models supported at the UE to a core network entity, and the UE may receive an indication of a list of machine learning models supported at the core network entity. The UE or the core network may initiate the configuration. For example, the UE may request to be configured with a machine learning model. The core network may send control signaling indicating a configuration for the machine learning model to the UE. The UE may perform analytics based on the machine learning model.

### CROSS REFERENCE

The present Application is a 371 national stage filing of International PCT Application No. PCT/CN2022/084328 by Zhang et al. entitled “DISTRIBUTED MACHINE LEARNING MODEL CONFIGURATIONS,” filed Mar. 31, 2022, which is assigned to the assignee hereof, and which is expressly incorporated by reference in its entirety herein.

### INTRODUCTION

The following relates to wireless communications, including machine learning model management.

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

### SUMMARY

A method for wireless communications at a UE is described. The method may include transmitting, to a core network entity, an indication of a first set of one or more machine learning models supported at the UE, receiving, from the core network entity, an indication of a second set of one or more machine learning models supported at the core network entity, receiving, from the core network entity, control signaling indicating a configuration for a machine learning model, the first set of one or more machine learning models including the machine learning model, and performing analytics based on the machine learning model.

An apparatus for wireless communications at a UE is described. The apparatus may include a processor, memory coupled with the processor, and instructions stored in the memory. The instructions may be executable by the processor to cause the apparatus to transmit, to a core network entity, an indication of a first set of one or more machine learning models supported at the UE, receive, from the core network entity, an indication of a second set of one or more machine learning models supported at the core network entity, receive, from the core network entity, control signaling indicating a configuration for a machine learning model, the first set of one or more machine learning models including the machine learning model, and perform analytics based on the machine learning model.

Another apparatus for wireless communications at a UE is described. The apparatus may include means for transmitting, to a core network entity, an indication of a first set of one or more machine learning models supported at the UE, means for receiving, from the core network entity, an indication of a second set of one or more machine learning models supported at the core network entity, means for receiving, from the core network entity, control signaling indicating a configuration for a machine learning model, the first set of one or more machine learning models including the machine learning model, and means for performing analytics based on the machine learning model.

A non-transitory computer-readable medium storing code for wireless communications at a UE is described. The code may include instructions executable by a processor to transmit, to a core network entity, an indication of a first set of one or more machine learning models supported at the UE, receive, from the core network entity, an indication of a second set of one or more machine learning models supported at the core network entity, receive, from the core network entity, control signaling indicating a configuration for a machine learning model, the first set of one or more machine learning models including the machine learning model, and perform analytics based on the machine learning model.

Some examples of the method, apparatuses, and non-transitory computer-readable medium described herein may further include operations, features, means, or instructions for transmitting, to the core network entity, a request for the machine learning model, where receiving the control signaling includes receiving the control signaling in response to transmitting the request.

In some examples of the method, apparatuses, and non-transitory computer-readable medium described herein, transmitting the request may include operations, features, means, or instructions for transmitting a service request message, where receiving the control signaling includes receiving the control signaling via a service response message.

In some examples of the method, apparatuses, and non-transitory computer-readable medium described herein, transmitting the request may include operations, features, means, or instructions for transmitting a protocol data unit session modification request message, where receiving the control signaling includes receiving the control signaling via a protocol data unit session modification command message.

In some examples of the method, apparatuses, and non-transitory computer-readable medium described herein, the request includes an identifier for the machine learning model.

Some examples of the method, apparatuses, and non-transitory computer-readable medium described herein may further include operations, features, means, or instructions for transmitting, to the core network entity, a completion message based on the control signaling indicating the configuration for the machine learning model.

In some examples of the method, apparatuses, and non-transitory computer-readable medium described herein, receiving the control signaling may include operations, features, means, or instructions for receiving the control signaling indicating the configuration for the machine learning model, the control signaling indicating a machine learning model file address, a machine learning model training request, a machine learning model inference request, a machine learning model identifier, a machine learning model location, a machine learning model version, a duration of time for performing the analytics, an activation event for reporting the analytics, or any combination thereof.

In some examples of the method, apparatuses, and non-transitory computer-readable medium described herein, receiving the control signaling may include operations, features, means, or instructions for receiving a UE configuration update command indicating the configuration for the machine learning model.

In some examples of the method, apparatuses, and non-transitory computer-readable medium described herein, transmitting the indication of the first set of one or more machine learning models may include operations, features, means, or instructions for transmitting a registration request indicating the first set of one or more machine learning models supported at the UE, where receiving the indication of the second set of one or more machine learning models includes receiving the indication of the second set of one or more machine learning models via a registration response message.

In some examples of the method, apparatuses, and non-transitory computer-readable medium described herein, receiving the control signaling may include operations, features, means, or instructions for receiving a protocol data unit session modification command indicating the configuration for the machine learning model.

Some examples of the method, apparatuses, and non-transitory computer-readable medium described herein may further include operations, features, means, or instructions for transmitting, to the core network entity, a protocol data unit session modification complete message based on the protocol data unit session modification command indicating the configuration for the machine learning model.

In some examples of the method, apparatuses, and non-transitory computer-readable medium described herein, transmitting the indication of the first set of one or more machine learning models may include operations, features, means, or instructions for transmitting a session establishment message or a modification request message indicating the first set of one or more machine learning models supported at the UE, where receiving the indication of the second set of one or more machine learning models includes receiving the indication of the second set of one or more machine learning models via a session establishment response message or a modification response message.

In some examples of the method, apparatuses, and non-transitory computer-readable medium described herein, receiving the control signaling may include operations, features, means, or instructions for receiving one or more parameters for the machine learning model, where performing the analytics includes performing the analytics based on the one or more parameters.

Some examples of the method, apparatuses, and non-transitory computer-readable medium described herein may further include operations, features, means, or instructions for obtaining the machine learning model from a core network based on an address indicated via the control signaling.

In some examples of the method, apparatuses, and non-transitory computer-readable medium described herein, the core network entity may be an access and mobility management function (AMF) entity or a session management function (SMF) entity.

A method for wireless communications at a first core network entity is described. The method may include obtaining an indication of a first set of one or more machine learning models supported at a UE, outputting an indication of a second set of one or more machine learning models supported at the first core network entity or a second core network entity, or both, and outputting control signaling indicating a configuration for a machine learning model, the first set of one or more machine learning model including the machine learning model.

An apparatus for wireless communications at a first core network entity is described. The apparatus may include a processor, memory coupled with the processor, and instructions stored in the memory. The instructions may be executable by the processor to cause the apparatus to obtain an indication of a first set of one or more machine learning models supported at a UE, output an indication of a second set of one or more machine learning models supported at the first core network entity or a second core network entity, or both, and output control signaling indicating a configuration for a machine learning model, the first set of one or more machine learning model including the machine learning model.

Another apparatus for wireless communications at a first core network entity is described. The apparatus may include means for obtaining an indication of a first set of one or more machine learning models supported at a UE, means for outputting an indication of a second set of one or more machine learning models supported at the first core network entity or a second core network entity, or both, and means for outputting control signaling indicating a configuration for a machine learning model, the first set of one or more machine learning model including the machine learning model.

A non-transitory computer-readable medium storing code for wireless communications at a first core network entity is described. The code may include instructions executable by a processor to obtain an indication of a first set of one or more machine learning models supported at a UE, output an indication of a second set of one or more machine learning models supported at the first core network entity or a second core network entity, or both, and output control signaling indicating a configuration for a machine learning model, the first set of one or more machine learning model including the machine learning model.

Some examples of the method, apparatuses, and non-transitory computer-readable medium described herein may further include operations, features, means, or instructions for obtaining a service request message requesting the machine learning model, where outputting the control signaling includes outputting the control signaling in response to the service request message via a service response message.

Some examples of the method, apparatuses, and non-transitory computer-readable medium described herein may further include operations, features, means, or instructions for obtaining a protocol data unit session modification request message requesting the machine learning model, where outputting the control signaling includes outputting the control signaling via a protocol data unit session modification command message in response to the protocol data unit session modification request message.

Some examples of the method, apparatuses, and non-transitory computer-readable medium described herein may further include operations, features, means, or instructions for obtaining a UE configuration update complete message in response to the control signaling indicating the configuration for the machine learning model, where outputting the control signaling includes outputting the control signaling via a UE configuration update command.

Some examples of the method, apparatuses, and non-transitory computer-readable medium described herein may further include operations, features, means, or instructions for obtaining a protocol data unit session modification complete message in response to the control signaling indicating the configuration for the machine learning model, where outputting the control signaling includes outputting the control signaling via a protocol data unit session modification command message.

Some examples of the method, apparatuses, and non-transitory computer-readable medium described herein may further include operations, features, means, or instructions for obtaining, from another core network entity, a request for the UE to perform analytics based on the machine learning model, where outputting the control signaling includes outputting the control signaling in response to the request.

In some examples of the method, apparatuses, and non-transitory computer-readable medium described herein, outputting the control signaling may include operations, features, means, or instructions for outputting the control signaling the configuration for the machine learning model, the control signaling indicating a machine learning model file address, a machine learning model training request, a machine learning model inference request, a machine learning model identifier, a machine learning model location, a machine learning model version, a duration of time for performing analytics according to the machine learning model, an activation event for reporting the analytics, one or more parameters for performing the analytics, or any combination thereof.

In some examples of the method, apparatuses, and non-transitory computer-readable medium described herein, outputting the indication of the first set of one or more machine learning models may include operations, features, means, or instructions for obtaining a registration request indicating the first set of one or more machine learning models supported at the UE, where outputting the indication of the second set of one or more machine learning models includes outputting the indication of the second set of one or more machine learning models via a registration response message.

In some examples of the method, apparatuses, and non-transitory computer-readable medium described herein, obtaining the indication of the first set of one or more machine learning models may include operations, features, means, or instructions for obtaining a session establishment message or a modification request message indicating the first set of one or more machine learning models supported at the UE, where outputting the indication of the second set of one or more machine learning models includes outputting the indication of the second set of one or more machine learning models via a session establishment response message or a modification response message.

In some examples of the method, apparatuses, and non-transitory computer-readable medium described herein, the first core network entity may be an AMF entity.

Some examples of the method, apparatuses, and non-transitory computer-readable medium described herein may further include operations, features, means, or instructions for outputting the indication of the first set of one or more machine learning models supported at the UE to an SMF entity, where the second core network entity may be the SMF entity, obtaining, from the SMF entity, the indication of the second set of one or more machine learning models supported at the SMF entity, and obtaining, from the SMF entity, the control signaling indicating the configuration for the machine learning model.

In some examples of the method, apparatuses, and non-transitory computer-readable medium described herein, the first core network entity may be an SMF entity.

Some examples of the method, apparatuses, and non-transitory computer-readable medium described herein may further include operations, features, means, or instructions for obtaining the indication of the first set of one or more machine learning models supported at the UE from an AMF entity, where the second core network entity may be the AMF entity, outputting, to the AMF entity, the indication of the second set of one or more machine learning models supported at the SMF entity, and outputting, to the AMF entity, the control signaling indicating the configuration for the machine learning model.

### BRIEF DESCRIPTION OF THE DRAWINGS

FIG. 1 illustrates an example of a wireless communications system that supports distributed machine learning model configurations in accordance with aspects of the present disclosure.

FIG. 2 illustrates an example of a wireless communications system that supports distributed machine learning model configurations in accordance with aspects of the present disclosure.

FIG. 3 illustrates an example of a capability exchange procedure that supports distributed machine learning model configurations in accordance with aspects of the present disclosure.

FIGS. 4 and 5 illustrate examples of network-initiated machine learning model configurations that support distributed machine learning model configurations in accordance with aspects of the present disclosure.

FIGS. 6 and 7 illustrate examples of UE-initiated machine learning model configurations that support distributed machine learning model configurations in accordance with aspects of the present disclosure.

FIG. 8 illustrates an example of a machine learning process that supports distributed machine learning model configurations in accordance with aspects of the present disclosure.

FIGS. 9 and 10 show block diagrams of devices that support distributed machine learning model configurations in accordance with aspects of the present disclosure.

FIG. 11 shows a block diagram of a communications manager that supports distributed machine learning model configurations in accordance with aspects of the present disclosure.

FIG. 12 shows a diagram of a system including a device that supports distributed machine learning model configurations in accordance with aspects of the present disclosure.

FIGS. 13 and 14 show block diagrams of devices that support distributed machine learning model configurations in accordance with aspects of the present disclosure.

FIG. 15 shows a block diagram of a communications manager that supports distributed machine learning model configurations in accordance with aspects of the present disclosure.

FIG. 16 shows a diagram of a system including a device that supports distributed machine learning model configurations in accordance with aspects of the present disclosure.

FIGS. 17 through 21 show flowcharts illustrating methods that support distributed machine learning model configurations in accordance with aspects of the present disclosure.

### DETAILED DESCRIPTION

A core network of a wireless communications system may train a machine learning model to perform analytics, such as network optimizations and inferences. A UE in the wireless communications system may also support performing analytics based on a machine learning model. For example, the core network may configure the UE with a trained machine learning model, and the UE may perform analytics using the trained machine learning model. The UE may obtain inference results from the trained machine learning model, and the inference results may be used for local optimizations at the UE or reported to the core network for core network optimizations.

The present disclosure provides techniques for configuring a machine learning model at a UE using distributed architecture. A core network entity, such as an AMF entity, may manage, store, or support one or more machine learning models associated with functionality of the core network entity. For example, the AMF entity may manage one or more AMF machine learning models, and an SMF entity may manage one or more SMF machine learning models. The AMF entity may configure a UE with an AMF machine learning model, and the UE may perform analytics using the AMF machine learning model. In some cases, to support the distributed architecture techniques, a UE and core network entities may exchange capability information. For example, the UE may indicate, to an AMF entity and an SMF entity, a set of machine learning models supported at the UE. The AMF entity and the SMF entity may each indicate respectively supported machine learning models to the UE. In another example, a policy control function (PCF) entity may manage one or more PCF machine learning models, as may other network entities of the core network with different functions manage machine learning models related to those functionalities.

A system which does not support performing machine learning model training or analytics at a UE may be less efficient, performing local device management or network management (e.g., network load management, split rendering for virtual reality, extended reality, or augmented reality techniques, etc.) based on less information or fewer inferences (e.g., only network-side inferences and analytics). However, by implementing techniques described herein, a UE or a network entity, or both, may perform local device management or network management based on inferences or analytics performed at both the UE and the network entity, which may provide more information for the UE or network entity, or both, to perform more optimized device or network management. For example, a UE may use network load analytics to predict a network load for different radio access technologies (RATs) (e.g. 4G or 5G) and register to a RAT based on the network load prediction. In another example, for a specific protocol data unit (PDU) session, a UE may determine to establish the PDU session via different access technologies based on the network load prediction. In another example, by implementing these techniques, the UE may provide the network load prediction analytics to a UE application client, and the application client can determine whether to initiate a high bit rate data transmission. The network may provide a UE list to a requesting entity, node, or consumer based on a request from the entity, node, or consumer. For example, an application function may request the UE list within a specific location, and the network may request for UEs to provide network load predictions and provide the UE list to the application function.

Either the UE or the core network may initiate the procedure to configure the UE with a machine learning model. In some cases, the UE may initiate the procedure by transmitting a request for a machine learning model to a core network entity that supports the machine learning model. For example, the UE may determine that an AMF entity supports an AMF machine learning model after exchanging capability information with the AMF entity, and the UE may transmit a request to the AMF entity to be configured with the AMF machine learning model. In some cases, a core network entity may receive a request, such as from a consumer or another network entity, for a UE to perform analytics using a machine learning model. The core network entity may configure the UE with the machine learning model based on the request. For example, another core network entity may request for an SMF entity to obtain SMF analytics from a UE based on an SMF machine learning model. The SMF may identify a UE which supports the SMF machine learning model and configure the UE with the SMF machine learning model based on receiving the request. The SMF analytics may be, for example, a request for information related to user experience for a UE or a request for information related to user experience for a network slice.

In some cases, the UE may obtain a machine learning model from the core network. For example, a core network entity may transmit control signaling to the UE configuring or indicating the machine learning model. The control signaling may include, for example, an address or location for the machine learning model (e.g., a Uniform Resource Locator (URL) or a Fully Qualified Domain Name (FQDN)), and the UE may obtain the machine learning model from the core network via the address or the location for the machine learning model.

The UE may perform analytics based on the machine learning model. Performing the analytics may enable some optimizations at the UE or at the core network. For example, the UE may request to perform the analytics to achieve UE optimizations based on inferences determined from the machine learning model. In some cases, the UE may use the machine learning model for network load analytic, and the UE may request for the network to provide the machine learning model or an analytics result. The UE may perform analytics using the machine learning model or use the analytics results to perform network selection to a network with a low network load, increasing throughput and reducing latency and network load bearing. For example, a UE may report, to an AMF entity, analytics or inferences determined by using a machine learning model to analyze a load prediction of the network, and an AMF entity may adjust network resources to avoid an overload on the network. In another example, a UE may report analytics or inferences associated with user experience to an SMF entity, and the SMF entity may adjust network resource allocation to improve data transmission performance.

Performing analytics at the UE or training a machine learning model at the UE may provide more information for performing network selection or network load management than performing analytics or inferences at the network-side alone. Additionally, or alternatively, a core network entity may request for the UE to perform analytics and report information obtained from performing the analytics, which may enable optimizations at the core network or the core network entity based on the reported information. For example, an application client may request for the UE to perform analytics using a machine learning model, and the UE may report analytics information from the machine learning model. The application client may use the reported information for, for example, split rendering, reducing processing power at the UE or network, or both.

Aspects of the disclosure are initially described in the context of wireless communications systems. Aspects of the disclosure are further illustrated by and described with reference to apparatus diagrams, system diagrams, and flowcharts that relate to distributed machine learning model configurations.

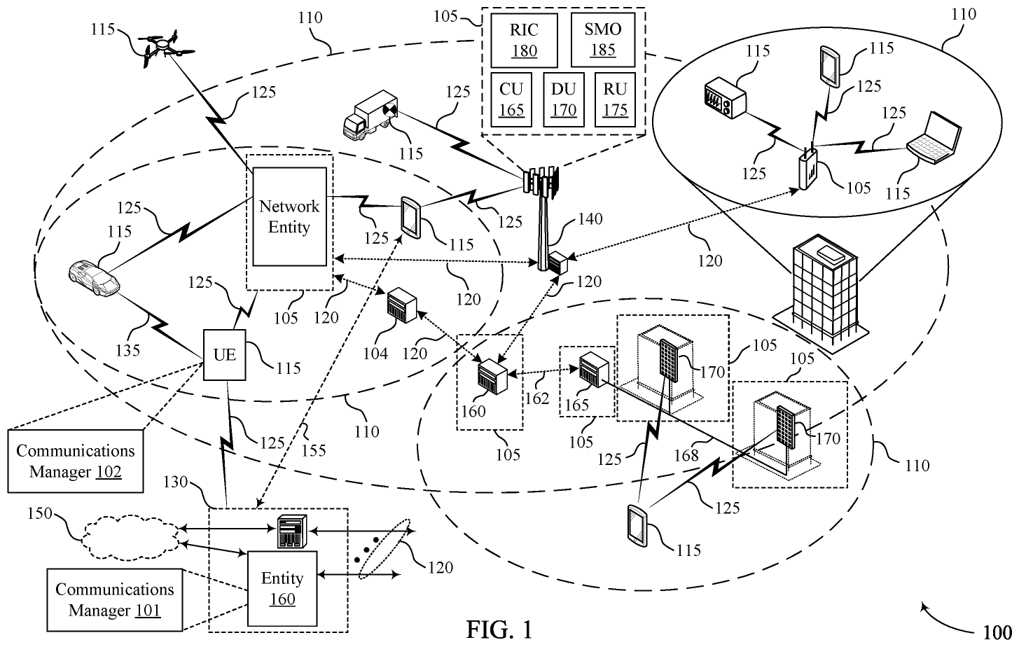

FIG. 1 illustrates an example of a wireless communications system 100 that supports distributed machine learning model configurations in accordance with aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115 or network entities 105, as shown in FIG. 1.

As described herein, anode of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another over a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof Δ UE 115 may communicate with the core network 130 through a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 165, a distributed unit (DU) 170, a radio unit (RU) 175, a RAN Intelligent Controller (RIC) 180 (e.g., a Near-Real Time RIC (Near-RT RIC), a Non-Real Time RIC (Non-RT RIC)), a Service Management and Orchestration (SMO) 185 system, or any combination thereof Δn RU 175 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 165, a DU 170, and an RU 175 is flexible and may support different functionalities depending upon which functions (e.g., network layer functions, protocol layer functions, baseband functions, RF functions, and any combinations thereof) are performed at a CU 165, a DU 170, or an RU 175. For example, a functional split of a protocol stack may be employed between a CU 165 and a DU 170 such that the CU 165 may support one or more layers of the protocol stack and the DU 170 may support one or more different layers of the protocol stack. In some examples, the CU 165 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 165 may be connected to one or more DUs 170 or RUs 175, and the one or more DUs 170 or RUs 175 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 165. Additionally, or alternatively, a functional split of the protocol stack may be employed between a DU 170 and an RU 175 such that the DU 170 may support one or more layers of the protocol stack and the RU 175 may support one or more different layers of the protocol stack. The DU 170 may support one or multiple different cells (e.g., via one or more RUs 175). In some cases, a functional split between a CU 165 and a DU 170, or between a DU 170 and an RU 175 may be within a protocol layer (e.g., some functions for a protocol layer may be performed by one of a CU 165, a DU 170, or an RU 175, while other functions of the protocol layer are performed by a different one of the CU 165, the DU 170, or the RU 175). A CU 165 may be functionally split further into CU control plane (CU-CP) and CU user plane (CU-UP) functions. A CU 165 may be connected to one or more DUs 170 via a midhaul communication link 162 (e.g., F1, F1-c, F1-u), and a DU 170 may be connected to one or more RUs 175 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication over such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 170 or one or more RUs 175 may be partially controlled by one or more CUs 165 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 170 of a coupled IAB donor. An IAB-MT may include an independent set of antennas for relay of communications with UEs 115, or may share the same antennas (e.g., of an RU 175) of an IAB node 104 used for access via the DU 170 of the IAB node 104 (e.g., referred to as virtual IAB-MT (vIAB-MT)). In some examples, the IAB nodes 104 may include DUs 170 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 165 and at least one DU 170 (e.g., and RU 175), in which case the CU 165 may communicate with the core network 130 over an interface (e.g., a backhaul link). IAB donor and IAB nodes 104 may communicate over an F1 interface according to a protocol that defines signaling messages (e.g., an F1 AP protocol). Additionally, or alternatively, the CU 165 may communicate with the core network over an interface, which may be an example of a portion of backhaul link, and may communicate with other CUs 165 (e.g., a CU 165 associated with an alternative IAB donor) over an Xn-C interface, which may be an example of a portion of a backhaul link.

An IAB node 104 may refer to a RAN node that provides IAB functionality (e.g., access for UEs 115, wireless self-backhauling capabilities). A DU 170 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 170) may provide a Uu interface for a parent IAB node 104 to signal to a child IAB node 104 or UE 115.

For example, IAB node 104 may be referred to as a parent node that supports communications for a child IAB node, and referred to as a child IAB node associated with an IAB donor. The IAB donor may include a CU 165 with a wired or wireless connection (e.g., a backhaul communication link 120) to the core network 130 and may act as parent node to IAB nodes 104. For example, the DU 170 of IAB donor may relay transmissions to UEs 115 through IAB nodes 104, and may directly signal transmissions to a UE 115. The CU 165 of IAB donor may signal communication link establishment via an F1 interface to IAB nodes 104, and the IAB nodes 104 may schedule transmissions (e.g., transmissions to the UEs 115 relayed from the IAB donor) through the DUs 170. That is, data may be relayed to and from IAB nodes 104 via signaling over an NR Uu interface to MT of the IAB node 104. Communications with IAB node 104 may be scheduled by a DU 170 of IAB donor and communications with IAB node 104 may be scheduled by DU 170 of IAB node 104.

In the case of the techniques described herein applied in the context of a disaggregated RAN architecture, one or more components of the disaggregated RAN architecture may be configured to support distributed machine learning model configurations as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 170, CUs 165, RUs 175, RIC 180, SMO 185).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) over one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 165, a DU 170, a RU 175) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be positioned according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications over a particular carrier bandwidth or may be configurable to support communications over one of a set of carrier bandwidths. In some examples, the wireless communications system 100 may include network entities 105 or UEs 115 that support concurrent communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both) such that the more resource elements that a device receives and the higher the order of the modulation scheme, the higher the data rate may be for the device. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of T_{S}=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., over a carrier) and may be associated with an identifier for distinguishing neighboring cells (e.g., a physical cell identifier (PCID), a virtual cell identifier (VCID), or others). In some examples, a cell may also refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 175) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be able to communicate directly with other UEs 115 over a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 175), which may support aspects of such D2D communications being configured by or scheduled by the network entity 105. In some examples, one or more UEs 115 in such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without the involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 175) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC), 5G core (5GC), or other generations or systems, which may include at least one control plane entity that manages access and mobility (e.g., a mobility management entity (MME), an AMF entity) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, which may be referred to as clusters, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 175), and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. While operating in unlicensed RF spectrum bands, devices such as the network entities 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A network entity 105 (e.g., a base station 140, an RU 175) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located in diverse geographic locations. A network entity 105 may have an antenna array with a set of rows and columns of antenna ports that the network entity 105 may use to support beamforming of communications with a UE 115. Likewise, a UE 115 may have one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 175) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 175), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate over logical channels. A MAC layer may perform priority handling and multiplexing of logical channels into transport channels. The MAC layer may also use error detection techniques, error correction techniques, or both to support retransmissions at the MAC layer to improve link efficiency. In the control plane, the RRC protocol layer may provide establishment, configuration, and maintenance of an RRC connection between a UE 115 and a network entity 105 or a core network 130 supporting radio bearers for user plane data. At the PHY layer, transport channels may be mapped to physical channels.

The UEs 115 and the network entities 105 may support retransmissions of data to increase the likelihood that data is received successfully. Hybrid automatic repeat request (HARQ) feedback is one technique for increasing the likelihood that data is received correctly over a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In some other examples, the device may provide HARQ feedback in a subsequent slot, or according to some other time interval.

The present disclosure provides techniques for configuring a machine learning model at a UE 115 using distributed architecture. A core network entity 160, such as an AMF entity may manage, store, or support one or more machine learning models associated with functionality of the core network entity 160. For example, the AMF entity may manage one or more AMF machine learning models, and an SMF entity may manage one or more SMF machine learning models. The AMF entity may configure a UE 115 with an AMF machine learning model, and the UE 115 may perform analytics using the AMF machine learning model. In some cases, to support the distributed architecture techniques, a UE 115 and different core network entities may exchange capability information. For example, the UE 115 may indicate, to an AMF entity and an SMF entity, a list of machine learning models supported at the UE 115. The AMF entity and the SMF entity may each indicate respectively supported machine learning models to the UE. For example, the UE 115 may send a supported machine learning model identifier to the AMF entity during a registration procedure, and the AMF entity may store a capability of the UE 115 to support a machine learning model associated with the machine learning model identifier as part of a UE context.

Either the UE 115 or the core network may initiate the procedure to configure the UE 115 with a machine learning model. In some cases, the UE 115 may initiate the procedure by transmitting a request for a machine learning model to a core network entity 160 that supports the machine learning model. For example, the UE 115 may determine that an AMF entity supports an AMF machine learning model after exchanging capability information with the AMF entity, and the UE 115 may transmit a request to the AMF entity to be configured with the AMF machine learning model. In some cases, a core network entity 160 may receive a request for a UE 115 to perform analytics using a machine learning model, and the core network entity 160 may configure the UE 115 with the machine learning model based on the request. For example, another core network entity 160 may request for an SMF entity to obtain SMF analytics from a UE 115 based on an SMF machine learning model. The SMF may identify a UE 115 which supports the SMF machine learning model and configure the UE 115 with the SMF machine learning model based on receiving the request.

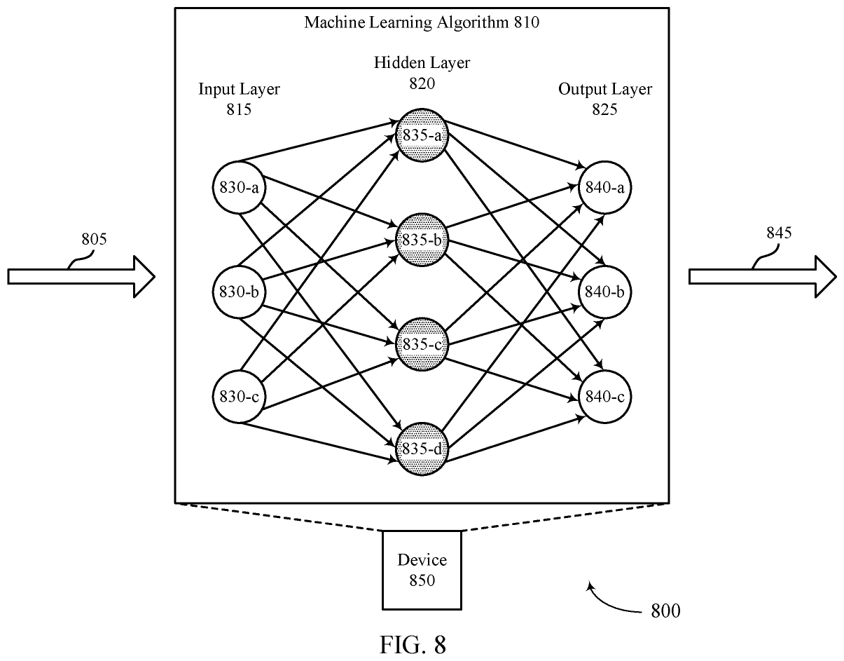

In some cases, the UE 115 may obtain a machine learning model from the core network. For example, a core network entity 160 may transmit control signaling to the UE 115 configuring or indicating the machine learning model. The control signaling may include, for example, an address or location for the machine learning model (e.g., a URL or an FQDN), and the UE 115 may obtain the machine learning model from the core network via the address or the location for the machine learning model. For example, the machine learning model configuration may be a file with many data packets. In some examples, instead of the core network entity (e.g., the AMF entity, SMF entity, etc.) providing the machine learning model to UE 115 directly via signaling (e.g., as this may bring significant overhead to the core network), the core network entity may indicate send the machine learning model configuration to UE 115 including a machine learning model file download address. The UE may download the machine learning model via user plane using the machine learning model file download address. Some additional techniques for training using a machine learning model are described in more detail with reference to FIG. 8.

In some examples, a core network entity 160, such as an AMF entity or an SMF entity, may include a communications manager 101 that is configured to support one or more aspects of the techniques for distributed machine learning model configurations described herein. For example, the communications manager 101 may be configured to support the core network entity 160 obtaining (e.g., receiving from a UE 115-a) an indication of a first set of one or more machine learning models supported at a UE 115, such as the UE 115-a. In some examples, the communications manager 101 may be configured to support the core network entity 160 outputting (e.g., to the UE 115-a) an indication of a second set of one or more machine learning models supported at the core network entity 160 or a second core network entity, or both. For example, the core network entity 160 may indicate machine learning models supported at the core network entity 160, or the core network entity may convey machine learning models which are supported at another network entity, such as an AMF entity transmitting NAS signaling to the UE 115-a to indicate machine learning models supported by an SMF entity. In some examples, the communications manager 101 may be configured to support the core network entity 160 outputting (e.g., to the UE 115-a) control signaling indicating a configuration for a machine learning model at the UE 115-a. In some examples, the first set of one or more machine learning models may include the machine learning model indicated by the control signaling.

In some examples, a UE 115-a may include a communications manager 102 that is configured to support one or more aspects of the techniques for distributed machine learning model configurations described herein. For example, the communications manager 102 may be configured to support the UE 115-a transmitting (e.g., to a core network entity 160) an indication of a first set of one or more machine learning models supported at the UE 115-a. In some examples, the communications manager 102 may be configured to support the UE 115-a receiving, from the core network entity 160, an indication of a second set of one or more machine learning models supported at the core network entity 160. In some examples, the communications manager 102 may be configured to support the UE 115-a receiving (e.g., from the core network entity 160), control signaling indicating a configuration for a machine learning model at the UE 115-a, where the first set of one or more machine learning models includes the machine learning model. In some examples, the communications manager 102 may be configured to support the UE 115-a performing analytics based on the machine learning model.

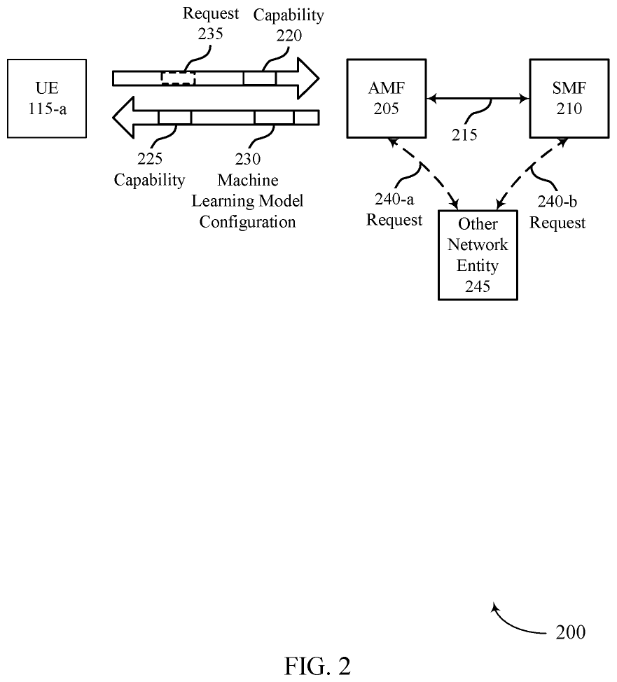

FIG. 2 illustrates an example of a wireless communications system 200 that supports distributed machine learning model configurations in accordance with aspects of the present disclosure.

The wireless communications system 200 may include a UE 115-a, which may be an example of a UE 115 as described with reference to FIG. 1. The wireless communications system 200 may include one or more entities of a core network, such as an AMF entity 205, an SMF entity 210, or both. In some cases, wireless communications system 200 may include another network entity 245, which may be an example of another entity in the core network, the AMF entity 205, the SMF entity 210, or any combination thereof. In some cases, the UE 115-a may communicate with the AMF entity 205 and the SMF entity 210 directly. Additionally, or alternatively, the UE 115-a may communicate with the AMF entity 205 and the SMF entity 210 by communicating NAS signaling via a network entity 105 or a base station. In some cases, the UE 115-a may communicate with the SMF entity 210 through the AMF entity 205, such as by transmitting or receiving SMF NAS signaling which is conveyed via the AMF entity 205 to or from the SMF entity 210. In some cases, the AMF entity 205 and the SMF entity 210 may communicate via a network link 215.

A core network of the wireless communications system 200 may train a machine learning model to perform analytics, such as network optimizations and inferences. UEs 115 in the wireless communications system 200, such as the UE 115-a, may also support performing analytics using a machine learning model. The wireless communications system 200 may implement an example configuration of a distributed architecture for configuring UEs 115, such as the UE 115-a, with a machine learning model which has been trained by the core network.

For a distributed architecture or a distributed configuration, a core network entity may manage, store, or support one or more machine learning models associated with functionality of the core network entity. For example, the AMF entity 205 may manage one or more AMF machine learning models, and the SMF entity 210 may manage one or more SMF machine learning models. The AMF entity 205 may, for example, support an AMF load analytics machine learning model or a misbehavior UE detection machine learning model. The SMF entity 210 may, for example, support a service experience analytics machine learning model.

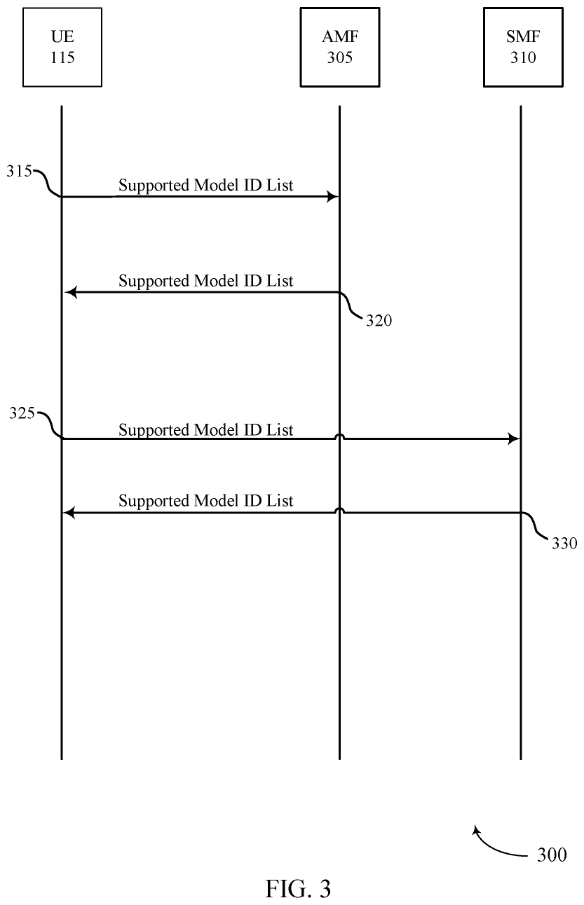

The UE 115-a and the different core network entities may exchange capability information. For example, the UE 115-a may transmit an indication of a capability 220 to support a list of machine learning models at the UE 115-a. The UE 115 may transmit the indication of the capability 220 to the AMF entity 205 or the SMF entity 210, or both. The UE 115-a may receive an indication of a capability 225 from the AMF entity 205 or the SMF entity 210, or both. The capability 225 may indicate a list of supported machine learning models at the AMF entity 205 or the SMF entity 210, or both. Additional techniques and signaling for the UE and network capability exchange are described in more detail with reference to FIG. 3.

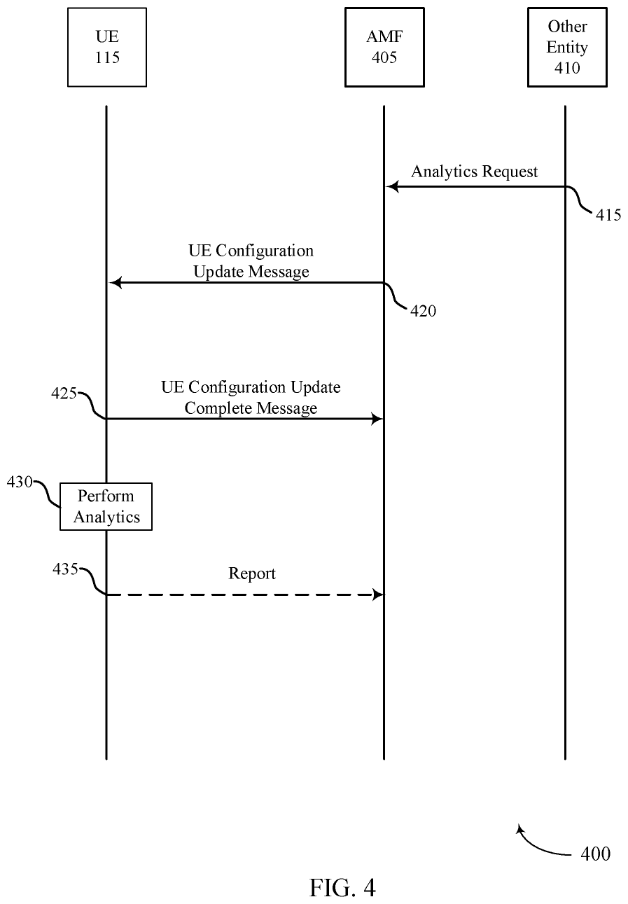

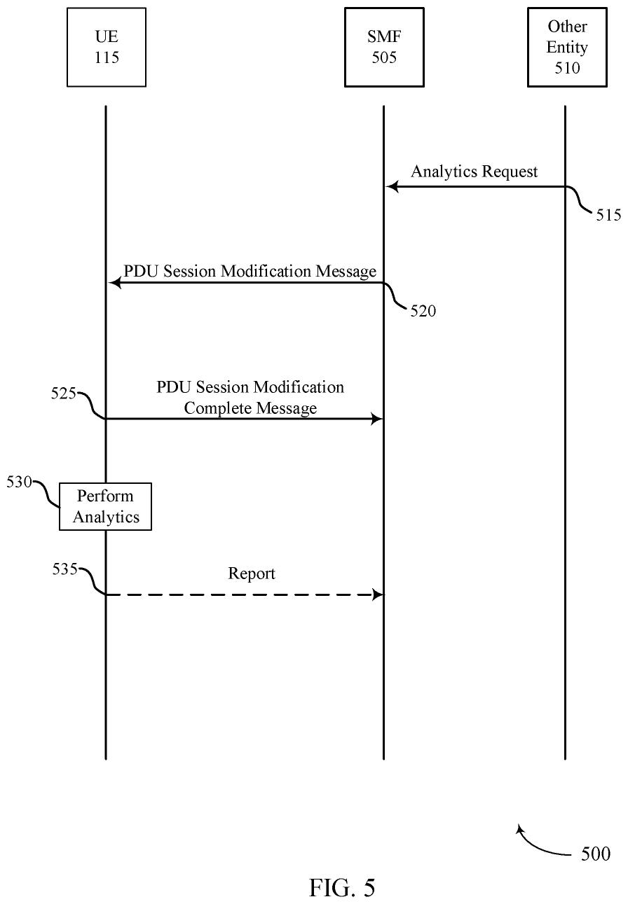

Either the UE 115-a or the core network may initiate the procedure to configure the UE 115-a with a machine learning model. In some cases, a core network entity may receive a request 240 for a UE to perform analytics using a machine learning model, and the core network entity may configure the UE with the machine learning model based on the request. For example, the other core network entity 245 may send a request 240-a for the AMF entity 205 to obtain AMF analytics from a UE 115 based on an AMF machine learning model. The AMF entity 205 may identify the UE 115-a as a UE 115 which supports the AMF machine learning model based on the UE and core network capability exchange. Additionally, or alternatively, the other core network entity 245 may send a request 240-b for the SMF entity 210 to obtain SMF analytics from the UE 115-a based on an SMF machine learning model, and the SMF entity 210 may identify the UE 115-a as a UE 115 which supports the SMF machine learning model. Some additional examples of network-initiated procedures are described in more detail with reference to FIGS. 4 and 5.

Additionally, or alternatively, the UE 115-a may initiate the procedure by transmitting a request 235 for a machine learning model to a core network entity that supports the machine learning model. In some cases, the UE 115-a may determine a machine learning model to request based on a function or operation performed at the UE 115-a. For example, if the UE 115-a is to perform network selection, the UE 115-a may request a machine learning model for network load from the AMF entity 205 to acquire the network load analytics. If the UE 115-a is performing an operation related to service experience, the UE 115-a may request a machine learning model for service experience from the SMF entity 210.

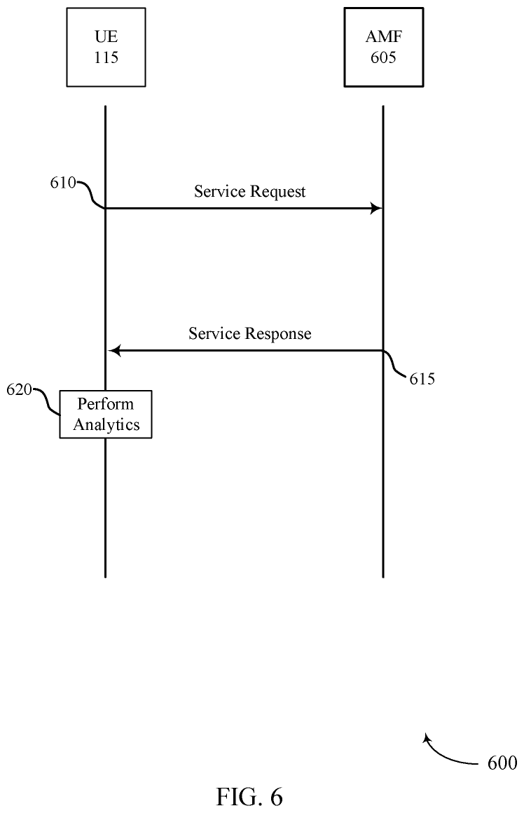

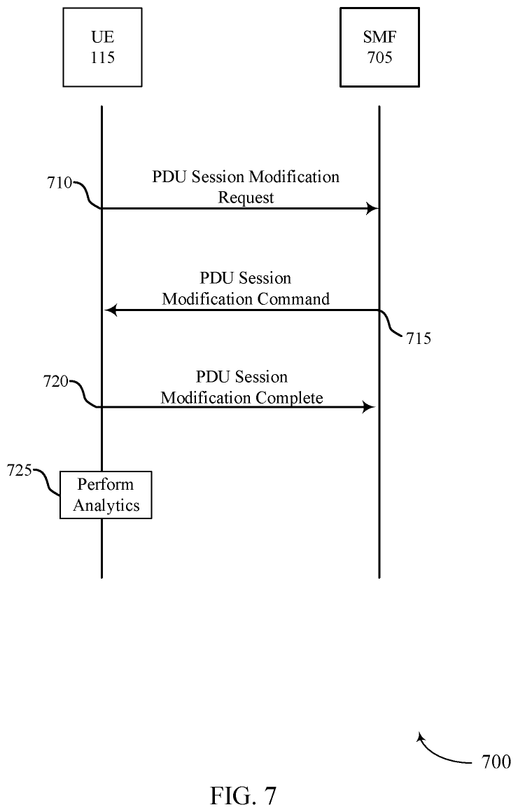

For example, the UE 115-a may determine that the AMF entity 205 supports an AMF machine learning model after exchanging capability information with the AMF entity 205, and the UE 115-a may transmit a request 235 to the AMF entity 205 to be configured with the AMF machine learning model. In another example, the UE 115-a may determine that the SMF entity 210 supports an SMF machine learning model after exchanging capability information with the SMF entity 210. The UE 115-a may transmit, to the SMF entity 210, the request 235 to be configured with the SMF machine learning model. Additional examples of UE-initiated procedures are described in more detail with reference to FIGS. 6 and 7.

The UE 115-a may receive control signaling from a core network entity indicating a configuration for a machine learning model at the UE 115-a. For example, the AMF entity 205 may transmit the control signaling to indicate a machine learning model configuration 230 for an AMF machine learning model at the UE 115-a, or the SMF entity 210 may transmit the control signaling to indicate a machine learning model configuration 230 for an SMF machine learning model at the UE 115-a. In some cases, the UE 115-a may obtain a machine learning model from the core network. For example, the control signaling may include, for example, an address or location for the machine learning model (e.g., a URL or an FQDN), and the UE 115-a may obtain the machine learning model from the core network via the address or the location for the machine learning model.

The UE 115-a may perform analytics based on the machine learning model. Performing the analytics may enable some optimizations at the UE 115-a or at the core network. For example, the UE 115-a may request to perform the analytics to achieve UE optimizations based on inferences determined from the machine learning model. Additionally, or alternatively, a core network entity may request for the UE 115-a to perform analytics and report information obtained from performing the analytics, which may enable optimizations at the core network or the core network entity based on the reported information. Some examples and techniques for using a machine learning model are described in more detail with reference to FIG. 8.

In some examples, the UE 115-a may report analytics, training information, or inferences determined based on the machine learning model. For example, the UE 115-a may transmit a report to one or more of the core network entities indicating the information. In some cases, the core network may use the reported information to perform optimizations at the core network. Additionally, or alternatively, the core network may update the machine learning model based on training performed by the UE 115-a. For example, a network entity of the core network may request for the UE 115-a to send an analytics result or a trained machine learning model to the core network, and core network may use analytics result or trained machine learning model to optimize the core network operations.

FIG. 3 illustrates an example of a capability exchange procedure 300 that supports distributed machine learning model configurations in accordance with aspects of the present disclosure.

The capability exchange procedure 300 may be implemented by a UE 115, an AMF entity 305, an SMF entity 310, or any combination thereof. The UE 115, the AMF entity 305, and the SMF entity 310 may be respective examples of a UE 115, an AMF entity 205, and an SMF entity 210 described with reference to FIG. 2. The processes and signaling of the capability exchange procedure 300 are exemplary and may occur in different orders in other examples. In some cases, some additional signaling or procedures not shown may be performed, or some signaling or procedures shown may not be performed in other examples.

A machine learning model may require certain software, hardware, machine learning data training platform, or any combination thereof, to support an operation of the machine learning model at a UE 115. If a UE 115 supports a machine learning model, the UE 115 may have the associated software or hardware, or both. In some cases, to support an application layer machine learning model, the UE 115 may have a configuration authorization from application to an application client of the UE 115. Different UEs 115 may have different capabilities to support different machine learning models.

The UE 115 may exchange capability information with different core network entities, such as the AMF entity 305 and the SMF entity 310. The UE 115 may indicate a list of machine learning models which are supported at the UE 115, and each core network entity may indicate a list of machine learning models which are supported at the core network entity. For example, the UE 115 may indicate the capability to the AMF entity 305 to indicate a support or capability of the UE 115 receiving a machine learning model configuration from the AMF entity 305. In some cases, an indication of supported machine learning models may include identifiers for the supported machine learning models.

For example, the UE 115 may transmit, to the AMF entity 305 at 315, an indication of a first set of one or more machine learning models supported at the UE 115. In some cases, the UE 115 may transmit a registration request including the indication of the UE capability. The AMF entity 305 may transmit, to the UE 115 at 320, an indication of machine learning models which are supported at the AMF entity 305. For example, the UE 115 may receive a second set of one or more machine learning models which are supported at the AMF entity 305. In some cases, the AMF entity 305 may transmit a registration response including the indication of the AMF capability.

In another example, the UE 115 may transmit, to the SMF entity 310 at 325, an indication of machine learning models which are supported at the UE 115. For example, the UE 115 may transmit an indication of the first set of one or more machine learning models supported at the UE 115. In some cases, the UE 115 may transmit a protocol data unit (PDU) session establishment message or a PDU session modification request including the indication of the UE capability. The SMF entity 310 may transmit, to the UE 115 at 330, an indication of machine learning models which are supported at the SMF entity 310. For example, the UE 115 may receive an indication of a set of one or more machine learning models supported at the SMF entity 310. In some cases, the SMF entity 310 may transmit a PDU session establishment message or a PDU session modification response message including the indication of the SMF capability.

FIG. 4 illustrates an example of a network-initiated machine learning model configuration 400 that supports distributed machine learning model configurations in accordance with aspects of the present disclosure.

The network-initiated machine learning model configuration 400 may be implemented by a UE 115, an AMF entity 405, and another network entity 410, or any combination thereof. The UE 115 and the AMF entity 405 may be respective examples of a UE 115 and an AMF entity 205 described with reference to FIG. 2. The other network entity 410 may be an example of another core network entity, such as an SMF or the like. The processes and signaling of the network-initiated machine learning model configuration 400 are exemplary and may occur in different orders in other examples. In some cases, some additional signaling or procedures not shown may be performed, or some signaling or procedures shown may not be performed in other examples.

A UE 115 or a core network may initiate a procedure to configure the UE 115 with a machine learning model for performing analytics. The network-initiated machine learning model configuration 400 shows an example of an AMF entity 405 receiving a request 415 from another entity 410 to configure the UE 115 with a machine learning model.

The AMF entity 405 may receive the analytics request from the other network entity 410 and determine to configure the UE 115 with a machine learning model in response to the analytics request. For example, the AMF entity 405 may determine UE-assisted model training or analytics is required to obtain the requested analytics.

In some cases, the analytics request may include a machine learning model identifier of a machine learning model for performing the analytics, and the AMF entity 405 may identify a UE 115 which is capable of supporting the machine learning model. For example, the AMF entity 405 may identify the UE 115 based on a UE and network capability exchange procedure as described with reference to FIG. 3. In some examples, different analytics operations may correspond to different analytics identifiers. The analytics request may include an analytics identifier corresponding to a requested analytics for one or more UEs 115 to perform, such as analytics identifiers corresponding to different service exchange operations or network load analysis operations.

The AMF entity 405 may transmit control signaling 420 to the UE 115 to configure the UE 115 with the machine learning model. The control signaling 420 may include machine learning model configuration information, which the UE 115 may use to obtain the machine learning model. For example, the UE 115 may receive, from the AMF entity 405, the control signaling 420 that indicates a configuration for a machine learning model at the UE 115, the machine learning model included in a first set of one or more machine learning models supported at the UE 115. In some cases, the AMF entity 405 may include machine learning model configuration information in a UE configuration update command message. Additionally, or alternatively, the AMF entity 405 may transmit a NAS message of a dedicated NAS signaling to transfer or indicate the machine learning model configuration message to the UE 115.

The machine learning model configuration information may include various information for the machine learning model. For example, the machine learning model may include a machine learning model file address, a machine learning model training request, a machine learning model inference request, the machine learning model information, an activation event, or any combination thereof. The machine learning model information may include, for example, a model identifier, a location of the machine learning model, a version of the machine learning model, a valid time for performing analytics according to the machine learning model, or any combination thereof.

The machine learning model file address may be, for example, a URL or an FQDN which the UE 115 may use to obtain or download the machine learning model from the core network. The machine learning model training request and the machine learning model inference request may indicate to the UE 115 how to use the machine learning model. For example, the machine learning model configuration information may request for the UE 115 to perform additional training on the machine learning model or for the UE 115 to perform inferences based on the machine learning model.

An activation event may indicate an event trigger to activate and use the machine learning model, such as by performing training, analytics, or inferences. For example, the activation event may configure the UE 115 to use the machine learning model within a certain time period or duration of receiving the machine learning model configuration information, to use the machine learning model when in a certain location or geographic area, to use the machine learning model immediately after obtaining or downloading the machine learning model, or any combination thereof.

In some cases, the machine learning model configuration information may configure an analytics identifier to decide an associated model. For example, the machine learning model configuration information may request for the UE 115 to perform a certain type of analytics, provide a certain type of information, inference, or analysis, or to perform a certain type of training using the model, or any combination thereof. The analytics identifier may be associated with the analytics request, where the machine learning model configuration includes a machine learning model file stored address, a validity time, the machine learning model identifier used to identify the machine learning model and the corresponding analytics identifier for this machine learning model. In some cases, the machine learning model configuration information may include a set of parameters for using the machine learning model. For example, the UE 115 may use the machine learning model based on the included set of parameters, performing analysis, inferences, or training based on the set of parameters.

In some cases, the UE 115 may transmit, to the AMF entity 405, a response message 425. For example, the UE 115 may transmit the response message 425 based on receiving the machine learning model configuration information or based on obtaining the machine learning model. In some cases, the UE 115 may transmit a UE configuration update complete NAS message to the AMF entity 405. In some other examples, the UE 115 may transmit a response message 425 using dedicated NAS signaling associated with machine learning configuration.

At 430, the UE 115 may perform analytics based on the machine learning model. For example, the UE 115 may perform inferences based on the machine learning model, train the machine learning model, or analyze network conditions based on the machine learning model. In some examples, the UE 115 may send a report of the analytics to the core network, such as by transmitting a report 435 to the AMF entity 405. In some cases, the AMF entity 405 may send the report to the other network entity 410. The core network may, in some cases, perform core network optimizations based on the report.

FIG. 5 illustrates an example of a network-initiated machine learning model configuration 500 that supports distributed machine learning model configurations in accordance with aspects of the present disclosure.

The network-initiated machine learning model configuration 500 may be implemented by a UE 115, an SMF entity 505, and another core network entity 510, or any combination thereof. The UE 115 and the SMF entity 505 may be respective examples of a UE 115 and an SMF entity 210 described with reference to FIG. 2. The other core network entity 510 may be an example of another core network entity, such as an AMF entity, or the like. The processes and signaling of the network-initiated machine learning model configuration 500 are exemplary and may occur in different orders in other examples. In some cases, some additional signaling or procedures not shown may be performed, or some signaling or procedures shown may not be performed in other examples.

A UE 115 or a core network may initiate a procedure to configure the UE 115 with a machine learning model for performing analytics. The network-initiated machine learning model configuration 500 shows an example of an SMF entity 505 receiving a request 515 from another core network entity 510 to configure the UE 115 with a machine learning model.

The SMF entity 505 may receive the analytics request from the other core network entity 510 and determine to configure the UE 115 with a machine learning model in response to the analytics request. For example, the SMF entity 505 may determine UE-assisted model training or analytics is required to obtain the requested analytics.

In some cases, the analytics request may include a machine learning model identifier of a machine learning model for performing the analytics, and the SMF entity 505 may identify a UE 115 which is capable of supporting the machine learning model. For example, the SMF entity 505 may identify the UE 115 based on a UE and network capability exchange procedure as described with reference to FIG. 3.

The SMF entity 505 may transmit control signaling 520 to the UE 115 to configure the UE 115 with the machine learning model. In some cases, the control signaling 520 may be transmitted as a NAS message via an AMF entity. The control signaling 520 may include machine learning model configuration information, which the UE 115 may use to obtain the machine learning model. For example, the UE 115 may receive, from the SMF entity 505, the control signaling 520 that indicates a configuration for a machine learning model at the UE 115, the machine learning model included in a first set of one or more machine learning models supported at the UE 115. In some cases, the SMF entity 505 may include machine learning model configuration information in a PDU session modification command message. Additionally, or alternatively, the SMF entity 505 may transmit a NAS message of a dedicated NAS signaling to transfer or indicate the machine learning model configuration message to the UE 115.

The machine learning model configuration information may include various information for the machine learning model. For example, the machine learning model may include a machine learning model file address, a machine learning model training request, a machine learning model inference request, the machine learning model information, an activation event, or any combination thereof. The machine learning model information may include, for example, a model identifier, a location of the machine learning model, a version of the machine learning model, a valid time for performing analytics according to the machine learning model, or any combination thereof.

The machine learning model file address may be, for example, a URL or an FQDN which the UE 115 may use to obtain or download the machine learning model from the core network. The machine learning model training request and the machine learning model inference request may indicate to the UE 115 how to use the machine learning model. For example, the machine learning model configuration information may request for the UE 115 to perform additional training on the machine learning model or for the UE 115 to perform inferences based on the machine learning model.

An activation event may indicate an event trigger to activate and use the machine learning model, such as by performing training, analytics, or inferences. For example, the activation event may configure the UE 115 to use the machine learning model within a certain time period or duration of receiving the machine learning model configuration information, to use the machine learning model when in a certain location or geographic area, to use the machine learning model immediately after obtaining or downloading the machine learning model, or any combination thereof.

In some cases, the machine learning model configuration information may configure an analytics identifier to decide an associated model. For example, the machine learning model configuration information may request for the UE 115 to perform a certain type of analytics, provide a certain type of information, inference, or analysis, or to perform a certain type of training using the model, or any combination thereof. In some cases, the machine learning model configuration information may include a set of parameters for using the machine learning model. For example, the UE 115 may use the machine learning model based on the included set of parameters, performing analysis, inferences, or training based on the set of parameters.

In some cases, the UE 115 may transmit, to the SMF entity 505, a response message 525. For example, the UE 115 may transmit the response message 525 based on receiving the machine learning model configuration information or based on obtaining the machine learning model. In some cases, the UE 115 may transmit a PDU session modification complete message to the SMF entity 505. In some other examples, the UE 115 may transmit a response message using dedicated NAS signaling associated with machine learning configuration.

At 530, the UE 115 may perform analytics based on the machine learning model. For example, the UE 115 may perform inferences based on the machine learning model, train the machine learning model, or analyze network conditions based on the machine learning model. In some examples, the UE 115 may send a report of the analytics to the core network, such as by transmitting a report 535 to the SMF entity 505. In some cases, the SMF entity 505 may send the report to the other core network entity 510. The core network may, in some cases, perform core network optimizations based on the report.

FIG. 6 illustrates an example of a UE-initiated machine learning model configuration 600 that supports distributed machine learning model configurations in accordance with aspects of the present disclosure.

The UE-initiated machine learning model configuration 600 may be implemented by a UE 115 and an AMF entity 605. The UE 115 and the AMF entity 605 may be respective examples of a UE 115 and an AMF entity 205 described with reference to FIG. 2. The processes and signaling of the UE-initiated machine learning model configuration 600 are exemplary and may occur in different orders in other examples. In some cases, some additional signaling or procedures not shown may be performed, or some signaling or procedures shown may not be performed in other examples.

A UE 115 or a core network may initiate a procedure to configure the UE 115 with a machine learning model for performing analytics. The UE-initiated machine learning model configuration 600 shows an example of a UE 115 transmitting, to the AMF entity 605, a request 610 to be configured with a machine learning model for the UE 115 to perform analytics with the machine learning model. The UE may include an identifier for the machine learning model with the request 610. In an example, the UE 115 may transmit a service request to the AMF entity 605 to request the machine learning model. The UE 115 may determine that the AMF entity 605 supports the machine learning model based on a UE and network capability exchange procedure as described with reference to FIG. 3.

The AMF entity 605 may transmit control signaling 615 to the UE 115 to configure the UE 115 with the machine learning model. The control signaling 615 may include machine learning model configuration information, which the UE 115 may use to obtain the machine learning model. For example, the UE 115 may receive, from the AMF entity 605, the control signaling 615 that indicates a configuration for a machine learning model at the UE 115, the machine learning model included in a first set of one or more machine learning models supported at the UE 115. In some cases, the AMF entity 605 may include machine learning model configuration information in a service request message. Additionally, or alternatively, the AMF entity 605 may transmit a NAS message of a dedicated NAS signaling to transfer or indicate the machine learning model configuration message to the UE 115.

The machine learning model configuration information may include the requested machine learning model information. In some cases, the machine learning model configuration information may include a machine learning model file address or an event filter, or both. The machine learning model file address may be, for example, a URL or an FQDN which the UE 115 may use to obtain or download the machine learning model from the core network. The event filter may, for example, include one or more filters for trigger-based or event-based reporting schemes. Additionally, or alternatively, the machine learning model configuration information may include any information as described with reference to the machine learning model configuration information of a network-initiated machine learning model configuration as described with reference to FIGS. 4 and 5.

At 620, the UE 115 may perform analytics based on the machine learning model. For example, the UE 115 may perform inferences based on the machine learning model, train the machine learning model, or analyze network conditions based on the machine learning model. In some examples, the UE 115 may send a report of the analytics to the core network. In some cases, UE 115 may perform UE-side optimizations based on the analytics.

FIG. 7 illustrates an example of a UE-initiated machine learning model configuration 700 that supports distributed machine learning model configurations in accordance with aspects of the present disclosure.

The UE-initiated machine learning model configuration 700 may be implemented by a UE 115 and an SMF entity 705. The UE 115 and the SMF entity 705 may be respective examples of a UE 115 and an SMF entity 210 described with reference to FIG. 2. The processes and signaling of the UE-initiated machine learning model configuration 700 are exemplary and may occur in different orders in other examples. In some cases, some additional signaling or procedures not shown may be performed, or some signaling or procedures shown may not be performed in other examples.

A UE 115 or a core network may initiate a procedure to configure the UE 115 with a machine learning model for performing analytics. The UE-initiated machine learning model configuration 700 shows an example of a UE 115 transmitting, to the SMF entity 705, a request 710 to be configured with a machine learning model for the UE 115 to perform analytics with the machine learning model. The UE 115 may include an identifier for the machine learning model with the request 710. In an example, the UE 115 may transmit a PDU session modification request to the SMF entity 705 to request the machine learning model. The UE 115 may determine that the SMF entity 705 supports the machine learning model based on a UE and network capability exchange procedure as described with reference to FIG. 3.

The SMF entity 705 may transmit control signaling 715 to the UE 115 to configure the UE 115 with the machine learning model. The control signaling 715 may include machine learning model configuration information, which the UE 115 may use to obtain the machine learning model. For example, the UE 115 may receive, from the SMF entity 705, the control signaling 715 that indicates a configuration for a machine learning model at the UE 115, the machine learning model included in a first set of one or more machine learning models supported at the UE 115. In some cases, the SMF entity 705 may include machine learning model configuration information in a PDU session modification command message. Additionally, or alternatively, the SMF entity 705 may transmit a NAS message of a dedicated NAS signaling to transfer or indicate the machine learning model configuration message to the UE 115.

The machine learning model configuration information may include the requested machine learning model information. In some cases, the machine learning model configuration information may include a machine learning model file address or an event filter, or both. The machine learning model file address may be, for example, a URL or an FQDN which the UE 115 may use to obtain or download the machine learning model from the core network. The event filter may, for example, include one or more filters for trigger-based or event-based reporting schemes. Additionally, or alternatively, the machine learning model configuration information may include any information as described with reference to the machine learning model configuration information of a network-initiated machine learning model configuration as described with reference to FIGS. 4 and 5.

The UE 115 may transmit a response message 720 to the SMF entity 705. For example, the UE 115 may transmit a PDU session modification complete message to the SMF entity 705.

At 725, the UE 115 may perform analytics based on the machine learning model. For example, the UE 115 may perform inferences based on the machine learning model, train the machine learning model, or analyze network conditions based on the machine learning model. In some examples, the UE 115 may send a report of the analytics to the core network. In some cases, UE 115 may perform UE-side optimizations based on the analytics.

FIG. 8 illustrates an example of a machine learning process 800 that supports distributed machine learning model configurations in accordance with aspects of the present disclosure. The machine learning process 800 may be implemented at a device 850, which may be an example of a core network entity, or a UE 115, or both as described with reference to FIGS. 1 through 7. In some examples, a UE 115 may perform techniques of the machine learning process 800 to perform analytics, inferences, or training based on a machine learning model. In some examples, the UE 115 may be configured with the machine learning model according to techniques described herein via separate or distributed core network entities, which may each manage one or more machine learning models associated with a function of the core network entity.

The machine learning process 800 may include a machine learning algorithm 810. The machine learning algorithm 810 may be implemented by the device 850. As illustrated, the machine learning algorithm 810 may be an example of a neural network, such as a feed forward (FF) or deep feed forward (DFF) neural network, a recurrent neural network (RNN), a long/short term memory (LSTM) neural network, or any other type of neural network. However, any other machine learning algorithms may be supported. For example, the machine learning algorithm 810 may implement a nearest neighbor algorithm, a linear regression algorithm, a Naïve Bayes algorithm, a random forest algorithm, or any other machine learning algorithm. Furthermore, the machine learning process 800 may involve supervised learning, unsupervised learning, semi-supervised learning, reinforcement learning, or any combination thereof.

The machine learning algorithm 810 may include an input layer 815, one or more hidden layers 820, and an output layer 825. In a fully connected neural network with one hidden layer 820, each hidden layer node 835 may receive a value from each input layer node 830 as input, where each input may be weighted. These neural network weights may be based on a cost function that is revised during training of the machine learning algorithm 810. Similarly, each output layer node 840 may receive a value from each hidden layer node 835 as input, where the inputs are weighted. If post-deployment training (e.g., online training) is supported, memory may be allocated to store errors and/or gradients for reverse matrix multiplication. These errors and/or gradients may support updating the machine learning algorithm 810 based on output feedback. Training the machine learning algorithm 810 may support computation of the weights (e.g., connecting the input layer nodes 830 to the hidden layer nodes 835 and the hidden layer nodes 835 to the output layer nodes 840) to map an input pattern to a desired output outcome. This training may result in a device-specific machine learning algorithm 810 based on the historic application data and data transfer for a specific network entity 105 or UE 115.

In some examples, input values 805 may be sent to the machine learning algorithm 810 for processing. In some example, preprocessing may be performed according to a sequence of operations on the input values 805 such that the input values 805 may be in a format that is compatible with the machine learning algorithm 810. The input values 805 may be converted into a set of k input layer nodes 830 at the input layer 815. In some cases, different measurements may be input at different input layer nodes 830 of the input layer 815. Some input layer nodes 830 may be assigned default values (e.g., values of 0) if the number of input layer nodes 830 exceeds the number of inputs corresponding to the input values 805. As illustrated, the input layer 815 may include three input layer nodes 830-a, 830-b, and 830-c. However, it is to be understood that the input layer 815 may include any number of input layer nodes 830 (e.g., 20 input nodes).

The machine learning algorithm 810 may convert the input layer 815 to a hidden layer 820 based on a number of input-to-hidden weights between the k input layer nodes 830 and the n hidden layer nodes 835. The machine learning algorithm 810 may include any number of hidden layers 820 as intermediate steps between the input layer 815 and the output layer 825. Additionally, each hidden layer 820 may include any number of nodes. For example, as illustrated, the hidden layer 820 may include four hidden layer nodes 835-a, 835-b, 835-c, and 835-d. However, it is to be understood that the hidden layer 820 may include any number of hidden layer nodes 835 (e.g., 10 input nodes). In a fully connected neural network, each node in a layer may be based on each node in the previous layer. For example, the value of hidden layer node 835-a may be based on the values of input layer nodes 830-a, 830-b, and 830-c (e.g., with different weights applied to each node value).

The machine learning algorithm 810 may determine values for the output layer nodes 840 of the output layer 825 following one or more hidden layers 820. For example, the machine learning algorithm 810 may convert the hidden layer 820 to the output layer 825 based on a number of hidden-to-output weights between the n hidden layer nodes 835 and the m output layer nodes 840. In some cases, n=m. Each output layer node 840 may correspond to a different output value 845 of the machine learning algorithm 810. As illustrated, the machine learning algorithm 810 may include three output layer nodes 840-a, 840-b, and 840-c, supporting three different threshold values. However, it is to be understood that the output layer 825 may include any number of output layer nodes 840. In some examples, post-processing may be performed on the output values 845 according to a sequence of operations such that the output values 845 may be in a format that is compatible with reporting the output values 845.

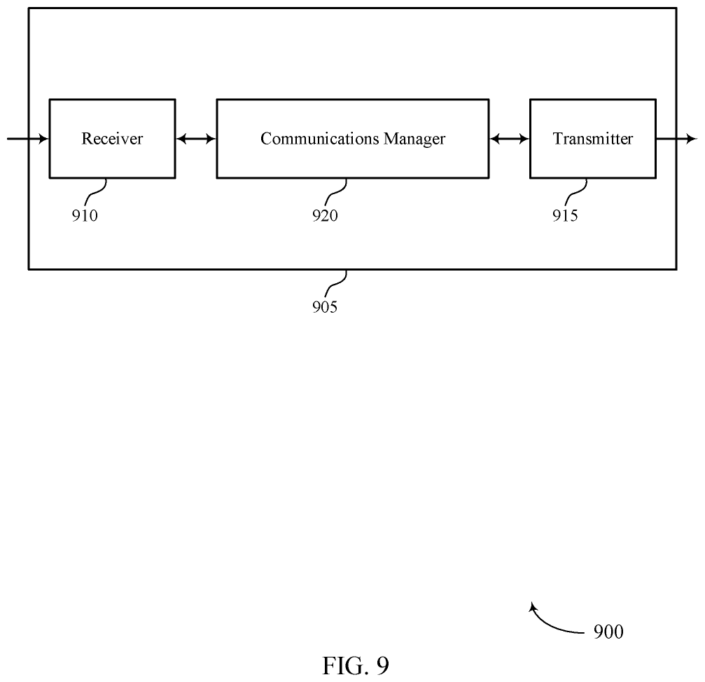

FIG. 9 shows a block diagram 900 of a device 905 that supports distributed machine learning model configurations in accordance with one or more aspects of the present disclosure. The device 905 may be an example of aspects of a UE 115 as described herein. The device 905 may include a receiver 910, a transmitter 915, and a communications manager 920. The device 905 may also include a processor. Each of these components may be in communication with one another (e.g., via one or more buses).

The receiver 910 may provide a means for receiving information such as packets, user data, control information, or any combination thereof associated with various information channels (e.g., control channels, data channels, information channels related to distributed machine learning model configurations). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to distributed machine learning model configurations). In some examples, the transmitter 915 may be co-located with a receiver 910 in a transceiver module. The transmitter 915 may utilize a single antenna or a set of multiple antennas.

The communications manager 920, the receiver 910, the transmitter 915, or various combinations thereof or various components thereof may be examples of means for performing various aspects of distributed machine learning model configurations as described herein. For example, the communications manager 920, the receiver 910, the transmitter 915, or various combinations or components thereof may support a method for performing one or more of the functions described herein.

In some examples, the communications manager 920, the receiver 910, the transmitter 915, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 920, the receiver 910, the transmitter 915, or various combinations or components thereof may be implemented in code (e.g., as communications management software or firmware) executed by a processor. If implemented in code executed by a processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications at a UE in accordance with examples as disclosed herein. For example, the communications manager 920 may be configured as or otherwise support a means for transmitting, to a core network entity, an indication of a first set of one or more machine learning models supported at the UE. The communications manager 920 may be configured as or otherwise support a means for receiving, from the core network entity, an indication of a second set of one or more machine learning models supported at the core network entity. The communications manager 920 may be configured as or otherwise support a means for receiving, from the core network entity, control signaling indicating a configuration for a machine learning model, the first set of one or more machine learning models including the machine learning model. The communications manager 920 may be configured as or otherwise support a means for performing analytics based on the machine learning model.

By including or configuring the communications manager 920 in accordance with examples as described herein, the device 905 (e.g., a processor controlling or otherwise coupled with the receiver 910, the transmitter 915, the communications manager 920, or a combination thereof) may support techniques for reduced power consumption by identifying optimizations at the device 905 based on performing inferences using a machine learning model.

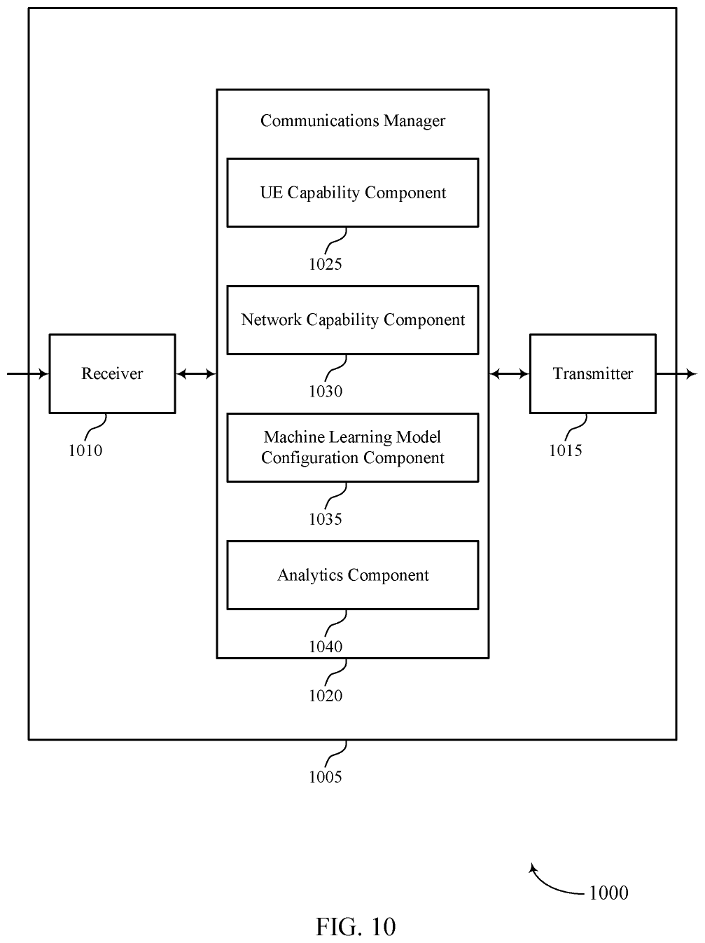

FIG. 10 shows a block diagram 1000 of a device 1005 that supports distributed machine learning model configurations in accordance with one or more aspects of the present disclosure. The device 1005 may be an example of aspects of a device 905 or a UE 115 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for receiving information such as packets, user data, control information, or any combination thereof associated with various information channels (e.g., control channels, data channels, information channels related to distributed machine learning model configurations). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to distributed machine learning model configurations). In some examples, the transmitter 1015 may be co-located with a receiver 1010 in a transceiver module. The transmitter 1015 may utilize a single antenna or a set of multiple antennas.

The device 1005, or various components thereof, may be an example of means for performing various aspects of distributed machine learning model configurations as described herein. For example, the communications manager 1020 may include a UE capability component 1025, a network capability component 1030, a machine learning model configuration component 1035, an analytics component 1040, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications at a UE in accordance with examples as disclosed herein. The UE capability component 1025 may be configured as or otherwise support a means for transmitting, to a core network entity, an indication of a first set of one or more machine learning models supported at the UE. The network capability component 1030 may be configured as or otherwise support a means for receiving, from the core network entity, an indication of a second set of one or more machine learning models supported at the core network entity. The machine learning model configuration component 1035 may be configured as or otherwise support a means for receiving, from the core network entity, control signaling indicating a configuration for a machine learning model, the first set of one or more machine learning models including the machine learning model. The analytics component 1040 may be configured as or otherwise support a means for performing analytics based on the machine learning model.

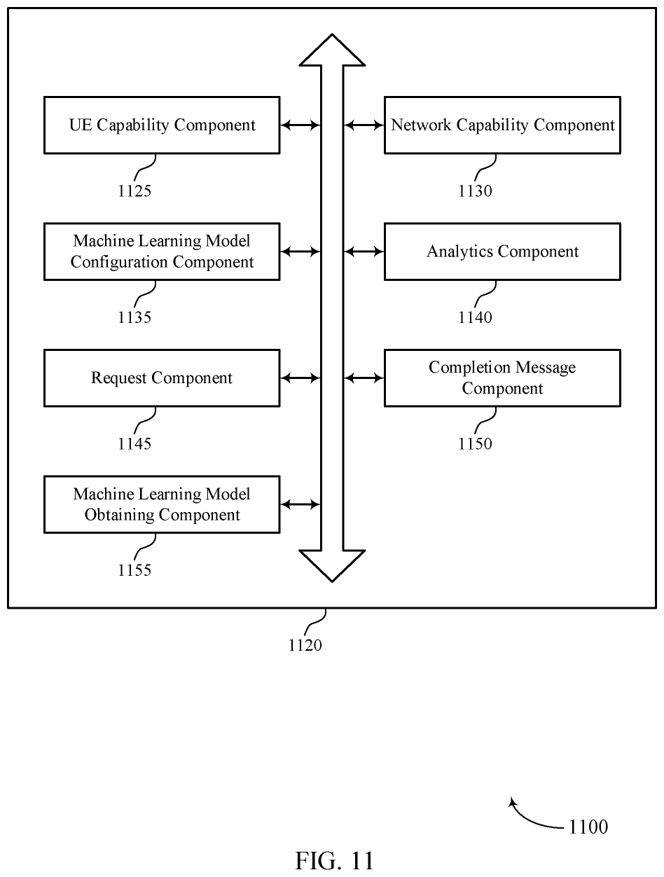

FIG. 11 shows a block diagram 1100 of a communications manager 1120 that supports distributed machine learning model configurations in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of distributed machine learning model configurations as described herein. For example, the communications manager 1120 may include a UE capability component 1125, a network capability component 1130, a machine learning model configuration component 1135, an analytics component 1140, a request component 1145, a completion message component 1150, a machine learning model obtaining component 1155, or any combination thereof. Each of these components may communicate, directly or indirectly, with one another (e.g., via one or more buses).

The communications manager 1120 may support wireless communications at a UE in accordance with examples as disclosed herein. The UE capability component 1125 may be configured as or otherwise support a means for transmitting, to a core network entity, an indication of a first set of one or more machine learning models supported at the UE. The network capability component 1130 may be configured as or otherwise support a means for receiving, from the core network entity, an indication of a second set of one or more machine learning models supported at the core network entity. The machine learning model configuration component 1135 may be configured as or otherwise support a means for receiving, from the core network entity, control signaling indicating a configuration for a machine learning model, the first set of one or more machine learning models including the machine learning model. The analytics component 1140 may be configured as or otherwise support a means for performing analytics based on the machine learning model.

In some examples, the request component 1145 may be configured as or otherwise support a means for transmitting, to the core network entity, a request for the machine learning model. In some examples, the machine learning model configuration component 1135 may be configured as or otherwise support a means for receiving the control signaling in response to transmitting the request.

In some examples, to support transmitting the request, the request component 1145 may be configured as or otherwise support a means for transmitting a service request message. In some examples, to support transmitting the request, the machine learning model configuration component 1135 may be configured as or otherwise support a means for receiving the control signaling via a service response message.

In some examples, to support transmitting the request, the request component 1145 may be configured as or otherwise support a means for transmitting a protocol data unit session modification request message. In some examples, to support transmitting the request, the machine learning model configuration component 1135 may be configured as or otherwise support a means for receiving the control signaling via a protocol data unit session modification command message. In some examples, the request includes an identifier for the machine learning model.

In some examples, the completion message component 1150 may be configured as or otherwise support a means for transmitting, to the core network entity, a completion message based on the control signaling indicating the configuration for the machine learning model.

In some examples, to support receiving the control signaling, the machine learning model configuration component 1135 may be configured as or otherwise support a means for receiving the control signaling indicating the configuration for the machine learning model, the control signaling indicating a machine learning model file address, a machine learning model training request, a machine learning model inference request, a machine learning model identifier, a machine learning model location, a machine learning model version, a duration of time for performing the analytics, an activation event for reporting the analytics, or any combination thereof.

In some examples, to support receiving the control signaling, the machine learning model configuration component 1135 may be configured as or otherwise support a means for receiving a UE configuration update command indicating the configuration for the machine learning model.

In some examples, to support transmitting the indication of the first set of one or more machine learning models, the UE capability component 1125 may be configured as or otherwise support a means for transmitting a registration request indicating the first set of one or more machine learning models supported at the UE. In some examples, to support transmitting the indication of the first set of one or more machine learning models, the network capability component 1130 may be configured as or otherwise support a means for receiving the indication of the second set of one or more machine learning models via a registration response message.

In some examples, to support receiving the control signaling, the machine learning model configuration component 1135 may be configured as or otherwise support a means for receiving a protocol data unit session modification command indicating the configuration for the machine learning model.

In some examples, the completion message component 1150 may be configured as or otherwise support a means for transmitting, to the core network entity, a protocol data unit session modification complete message based on the protocol data unit session modification command indicating the configuration for the machine learning model.

In some examples, to support transmitting the indication of the first set of one or more machine learning models, the UE capability component 1125 may be configured as or otherwise support a means for transmitting a session establishment message or a modification request message indicating the first set of one or more machine learning models supported at the UE. In some examples, to support transmitting the indication of the first set of one or more machine learning models, the network capability component 1130 may be configured as or otherwise support a means for receiving the indication of the second set of one or more machine learning models via a session establishment response message or a modification response message.

In some examples, to support receiving the control signaling, the machine learning model configuration component 1135 may be configured as or otherwise support a means for receiving one or more parameters for the machine learning model. In some examples, to support receiving the control signaling, analytics component 1140 may be configured as or otherwise support a means for performing the analytics based on the one or more parameters.

In some examples, the machine learning model obtaining component 1155 may be configured as or otherwise support a means for obtaining the machine learning model from a core network based on an address indicated via the control signaling. In some examples, the core network entity is an AMF entity or an SMF entity.

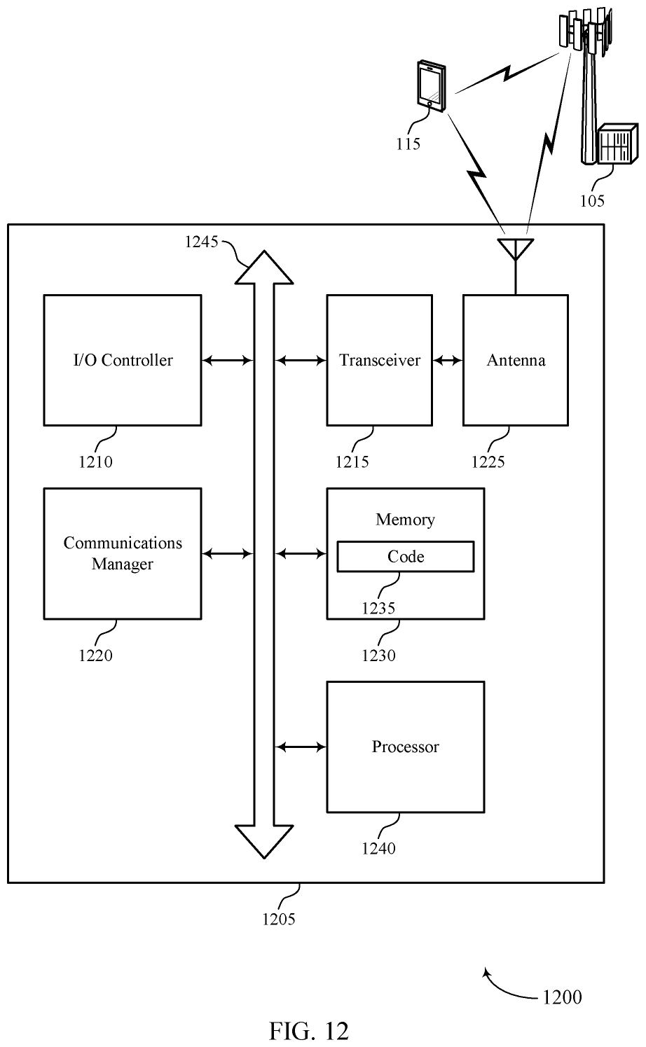

FIG. 12 shows a diagram of a system 1200 including a device 1205 that supports distributed machine learning model configurations in accordance with one or more aspects of the present disclosure. The device 1205 may be an example of or include the components of a device 905, a device 1005, or a UE 115 as described herein. The device 1205 may communicate (e.g., wirelessly) with one or more network entities 105, one or more UEs 115, or any combination thereof. The device 1205 may include components for bi-directional voice and data communications including components for transmitting and receiving communications, such as a communications manager 1220, an input/output (I/O) controller 1210, a transceiver 1215, an antenna 1225, a memory 1230, code 1235, and a processor 1240. These components may be in electronic communication or otherwise coupled (e.g., operatively, communicatively, functionally, electronically, electrically) via one or more buses (e.g., a bus 1245).

The I/O controller 1210 may manage input and output signals for the device 1205. The I/O controller 1210 may also manage peripherals not integrated into the device 1205. In some cases, the I/O controller 1210 may represent a physical connection or port to an external peripheral. In some cases, the I/O controller 1210 may utilize an operating system such as iOS®, ANDROID®, MS-DOS®, MS-WINDOWS®, OS/2®, UNIX®, LINUX®, or another known operating system. Additionally or alternatively, the I/O controller 1210 may represent or interact with a modem, a keyboard, a mouse, a touchscreen, or a similar device. In some cases, the I/O controller 1210 may be implemented as part of a processor, such as the processor 1240. In some cases, a user may interact with the device 1205 via the I/O controller 1210 or via hardware components controlled by the I/O controller 1210.

In some cases, the device 1205 may include a single antenna 1225. However, in some other cases, the device 1205 may have more than one antenna 1225, which may be capable of concurrently transmitting or receiving multiple wireless transmissions. The transceiver 1215 may communicate bi-directionally, via the one or more antennas 1225, wired, or wireless links as described herein. For example, the transceiver 1215 may represent a wireless transceiver and may communicate bi-directionally with another wireless transceiver. The transceiver 1215 may also include a modem to modulate the packets, to provide the modulated packets to one or more antennas 1225 for transmission, and to demodulate packets received from the one or more antennas 1225. The transceiver 1215, or the transceiver 1215 and one or more antennas 1225, may be an example of a transmitter 915, a transmitter 1015, a receiver 910, a receiver 1010, or any combination thereof or component thereof, as described herein.

The memory 1230 may include random access memory (RAM) and read-only memory (ROM). The memory 1230 may store computer-readable, computer-executable code 1235 including instructions that, when executed by the processor 1240, cause the device 1205 to perform various functions described herein. The code 1235 may be stored in a non-transitory computer-readable medium such as system memory or another type of memory. In some cases, the code 1235 may not be directly executable by the processor 1240 but may cause a computer (e.g., when compiled and executed) to perform functions described herein. In some cases, the memory 1230 may contain, among other things, a basic I/O system (BIOS) which may control basic hardware or software operation such as the interaction with peripheral components or devices.

The processor 1240 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1240 may be configured to operate a memory array using a memory controller. In some other cases, a memory controller may be integrated into the processor 1240. The processor 1240 may be configured to execute computer-readable instructions stored in a memory (e.g., the memory 1230) to cause the device 1205 to perform various functions (e.g., functions or tasks supporting distributed machine learning model configurations). For example, the device 1205 or a component of the device 1205 may include a processor 1240 and memory 1230 coupled with or to the processor 1240, the processor 1240 and memory 1230 configured to perform various functions described herein.

The communications manager 1220 may support wireless communications at a UE in accordance with examples as disclosed herein. For example, the communications manager 1220 may be configured as or otherwise support a means for transmitting, to a core network entity, an indication of a first set of one or more machine learning models supported at the UE. The communications manager 1220 may be configured as or otherwise support a means for receiving, from the core network entity, an indication of a second set of one or more machine learning models supported at the core network entity. The communications manager 1220 may be configured as or otherwise support a means for receiving, from the core network entity, control signaling indicating a configuration for a machine learning model, the first set of one or more machine learning models including the machine learning model. The communications manager 1220 may be configured as or otherwise support a means for performing analytics based on the machine learning model.

By including or configuring the communications manager 1220 in accordance with examples as described herein, the device 1205 may support techniques for improved coordination between devices by identifying optimizations at a UE 115 or a core network, or both, based on the UE 115 performing inferences using a machine learning model. For example, the UE 115 may perform network load analytics using the machine learning model to select a network with low load, reducing latency and network load bearing.

In some examples, the communications manager 1220 may be configured to perform various operations (e.g., receiving, monitoring, transmitting) using or otherwise in cooperation with the transceiver 1215, the one or more antennas 1225, or any combination thereof Δlthough the communications manager 1220 is illustrated as a separate component, in some examples, one or more functions described with reference to the communications manager 1220 may be supported by or performed by the processor 1240, the memory 1230, the code 1235, or any combination thereof. For example, the code 1235 may include instructions executable by the processor 1240 to cause the device 1205 to perform various aspects of distributed machine learning model configurations as described herein, or the processor 1240 and the memory 1230 may be otherwise configured to perform or support such operations.

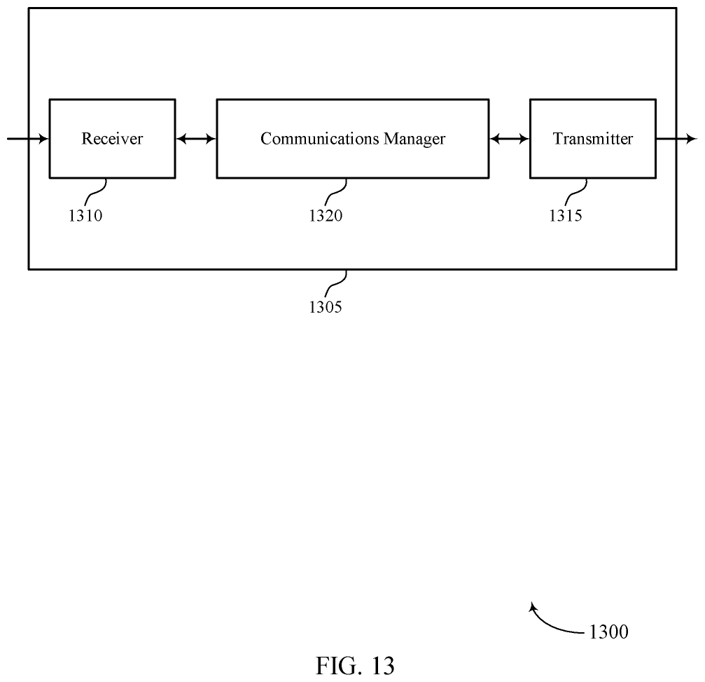

FIG. 13 shows a block diagram 1300 of a device 1305 that supports distributed machine learning model configurations in accordance with one or more aspects of the present disclosure. The device 1305 may be an example of aspects of a network entity 105 as described herein. The device 1305 may include a receiver 1310, a transmitter 1315, and a communications manager 1320. The device 1305 may also include a processor. Each of these components may be in communication with one another (e.g., via one or more buses).

The receiver 1310 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1305. In some examples, the receiver 1310 may support obtaining information by receiving signals via one or more antennas. Additionally, or alternatively, the receiver 1310 may support obtaining information by receiving signals via one or more wired (e.g., electrical, fiber optic) interfaces, wireless interfaces, or any combination thereof.

The transmitter 1315 may provide a means for outputting (e.g., transmitting, providing, conveying, sending) information generated by other components of the device 1305. For example, the transmitter 1315 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1315 may support outputting information by transmitting signals via one or more antennas. Additionally, or alternatively, the transmitter 1315 may support outputting information by transmitting signals via one or more wired (e.g., electrical, fiber optic) interfaces, wireless interfaces, or any combination thereof. In some examples, the transmitter 1315 and the receiver 1310 may be co-located in a transceiver, which may include or be coupled with a modem.

The communications manager 1320, the receiver 1310, the transmitter 1315, or various combinations thereof or various components thereof may be examples of means for performing various aspects of distributed machine learning model configurations as described herein. For example, the communications manager 1320, the receiver 1310, the transmitter 1315, or various combinations or components thereof may support a method for performing one or more of the functions described herein.

In some examples, the communications manager 1320, the receiver 1310, the transmitter 1315, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1320, the receiver 1310, the transmitter 1315, or various combinations or components thereof may be implemented in code (e.g., as communications management software or firmware) executed by a processor. If implemented in code executed by a processor, the functions of the communications manager 1320, the receiver 1310, the transmitter 1315, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1320 may be configured to perform various operations (e.g., receiving, obtaining, monitoring, outputting, transmitting) using or otherwise in cooperation with the receiver 1310, the transmitter 1315, or both. For example, the communications manager 1320 may receive information from the receiver 1310, send information to the transmitter 1315, or be integrated in combination with the receiver 1310, the transmitter 1315, or both to obtain information, output information, or perform various other operations as described herein.

The communications manager 1320 may support wireless communications at a first core network entity in accordance with examples as disclosed herein. For example, the communications manager 1320 may be configured as or otherwise support a means for obtaining an indication of a first set of one or more machine learning models supported at a UE. The communications manager 1320 may be configured as or otherwise support a means for outputting an indication of a second set of one or more machine learning models supported at the first core network entity or a second core network entity, or both. The communications manager 1320 may be configured as or otherwise support a means for outputting control signaling indicating a configuration for a machine learning model, the first set of one or more machine learning model including the machine learning model.

By including or configuring the communications manager 1320 in accordance with examples as described herein, the device 1305 (e.g., a processor controlling or otherwise coupled with the receiver 1310, the transmitter 1315, the communications manager 1320, or a combination thereof) may support techniques for reduced processing or more efficient utilization of communications resources based on inferences reported from a UE 115 determined based on a machine learning model.

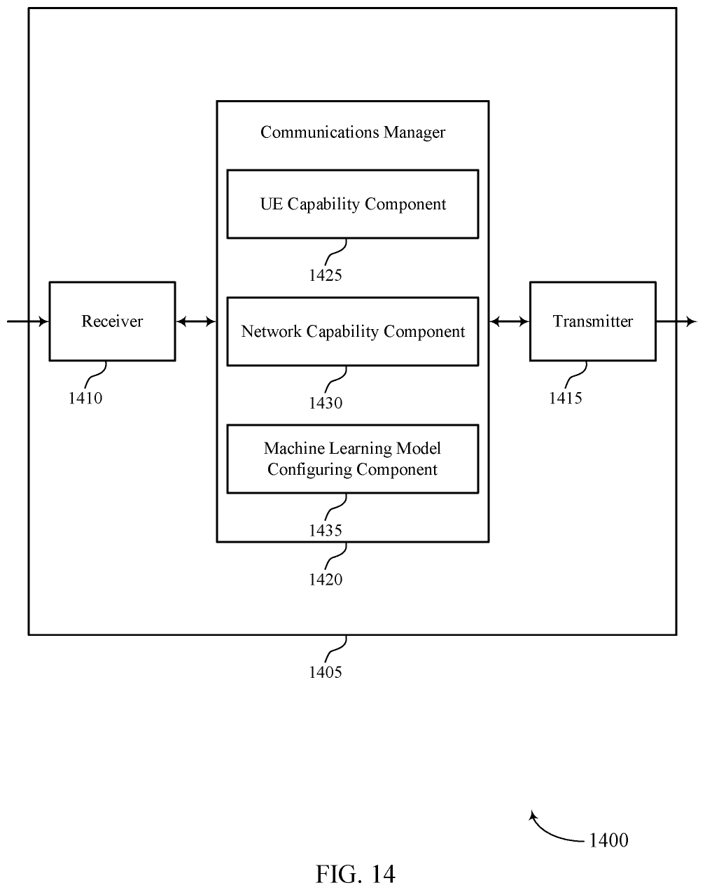

FIG. 14 shows a block diagram 1400 of a device 1405 that supports distributed machine learning model configurations in accordance with one or more aspects of the present disclosure. The device 1405 may be an example of aspects of a device 1305 or a network entity 105 as described herein. The device 1405 may include a receiver 1410, a transmitter 1415, and a communications manager 1420. The device 1405 may also include a processor. Each of these components may be in communication with one another (e.g., via one or more buses).

The receiver 1410 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1405. In some examples, the receiver 1410 may support obtaining information by receiving signals via one or more antennas. Additionally, or alternatively, the receiver 1410 may support obtaining information by receiving signals via one or more wired (e.g., electrical, fiber optic) interfaces, wireless interfaces, or any combination thereof.

The transmitter 1415 may provide a means for outputting (e.g., transmitting, providing, conveying, sending) information generated by other components of the device 1405. For example, the transmitter 1415 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1415 may support outputting information by transmitting signals via one or more antennas. Additionally, or alternatively, the transmitter 1415 may support outputting information by transmitting signals via one or more wired (e.g., electrical, fiber optic) interfaces, wireless interfaces, or any combination thereof. In some examples, the transmitter 1415 and the receiver 1410 may be co-located in a transceiver, which may include or be coupled with a modem.

The device 1405, or various components thereof, may be an example of means for performing various aspects of distributed machine learning model configurations as described herein. For example, the communications manager 1420 may include a UE capability component 1425, a network capability component 1430, a machine learning model configuring component 1435, or any combination thereof. The communications manager 1420 may be an example of aspects of a communications manager 1320 as described herein. In some examples, the communications manager 1420, or various components thereof, may be configured to perform various operations (e.g., receiving, obtaining, monitoring, outputting, transmitting) using or otherwise in cooperation with the receiver 1410, the transmitter 1415, or both. For example, the communications manager 1420 may receive information from the receiver 1410, send information to the transmitter 1415, or be integrated in combination with the receiver 1410, the transmitter 1415, or both to obtain information, output information, or perform various other operations as described herein.

The communications manager 1420 may support wireless communications at a first core network entity in accordance with examples as disclosed herein. The UE capability component 1425 may be configured as or otherwise support a means for obtaining an indication of a first set of one or more machine learning models supported at a UE. The network capability component 1430 may be configured as or otherwise support a means for outputting an indication of a second set of one or more machine learning models supported at the first core network entity or a second core network entity, or both. The machine learning model configuring component 1435 may be configured as or otherwise support a means for outputting control signaling indicating a configuration for a machine learning model, the first set of one or more machine learning model including the machine learning model.

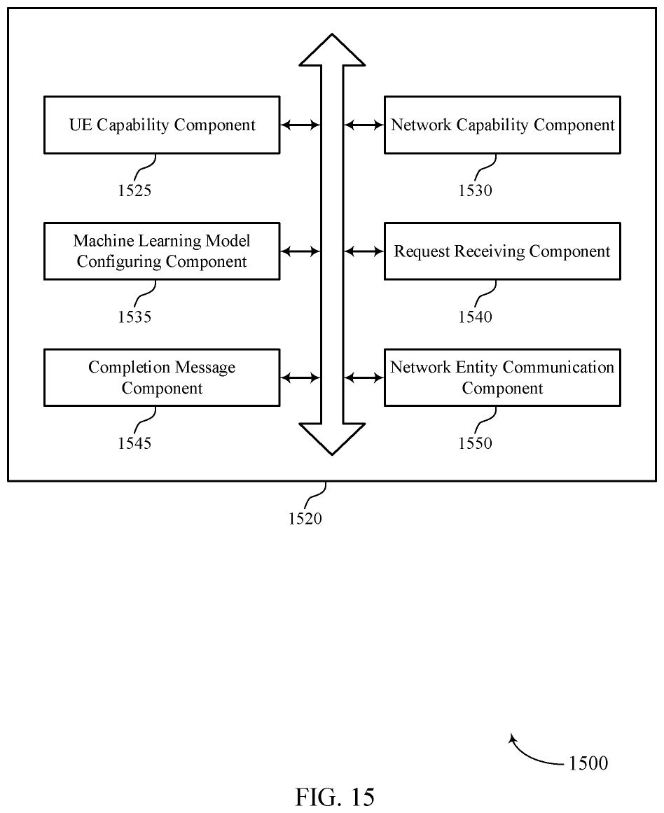

FIG. 15 shows a block diagram 1500 of a communications manager 1520 that supports distributed machine learning model configurations in accordance with one or more aspects of the present disclosure. The communications manager 1520 may be an example of aspects of a communications manager 1320, a communications manager 1420, or both, as described herein. The communications manager 1520, or various components thereof, may be an example of means for performing various aspects of distributed machine learning model configurations as described herein. For example, the communications manager 1520 may include a UE capability component 1525, a network capability component 1530, a machine learning model configuring component 1535, a request receiving component 1540, a completion message component 1545, a network entity communication component 1550, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1520 may support wireless communications at a first core network entity in accordance with examples as disclosed herein. The UE capability component 1525 may be configured as or otherwise support a means for obtaining an indication of a first set of one or more machine learning models supported at a UE. The network capability component 1530 may be configured as or otherwise support a means for outputting an indication of a second set of one or more machine learning models supported at the first core network entity or a second core network entity, or both. The machine learning model configuring component 1535 may be configured as or otherwise support a means for outputting control signaling indicating a configuration for a machine learning model, the first set of one or more machine learning model including the machine learning model.

In some examples, the request receiving component 1540 may be configured as or otherwise support a means for obtaining a service request message requesting the machine learning model. In some examples, the machine learning model configuring component 1535 may be configured as or otherwise support a means for outputting the control signaling in response to the service request message via a service response message.

In some examples, the request receiving component 1540 may be configured as or otherwise support a means for obtaining a protocol data unit session modification request message requesting the machine learning model. In some examples, the machine learning model configuring component 1535 may be configured as or otherwise support a means for outputting the control signaling via a protocol data unit session modification command message in response to the protocol data unit session modification request message.

In some examples, the completion message component 1545 may be configured as or otherwise support a means for obtaining a UE configuration update complete message in response to the control signaling indicating the configuration for the machine learning model. In some examples, the machine learning model configuring component 1535 may be configured as or otherwise support a means for outputting the control signaling via a UE configuration update command.

In some examples, the completion message component 1545 may be configured as or otherwise support a means for obtaining a protocol data unit session modification complete message in response to the control signaling indicating the configuration for the machine learning model. In some examples, the machine learning model configuring component 1535 may be configured as or otherwise support a means for outputting the control signaling via a protocol data unit session modification command message.

In some examples, the request receiving component 1540 may be configured as or otherwise support a means for obtaining, from another core network entity, a request for the UE to perform analytics based on the machine learning model. In some examples, the machine learning model configuring component 1535 may be configured as or otherwise support a means for outputting the control signaling in response to the request.

In some examples, to support outputting the control signaling, the machine learning model configuring component 1535 may be configured as or otherwise support a means for outputting the control signaling the configuration for the machine learning model, the control signaling indicating a machine learning model file address, a machine learning model training request, a machine learning model inference request, a machine learning model identifier, a machine learning model location, a machine learning model version, a duration of time for performing analytics according to the machine learning model, an activation event for reporting the analytics, one or more parameters for performing the analytics, or any combination thereof.

In some examples, to support outputting the indication of the first set of one or more machine learning models, the UE capability component 1525 may be configured as or otherwise support a means for obtaining a registration request indicating the first set of one or more machine learning models supported at the UE. In some examples, to support outputting the indication of the first set of one or more machine learning models, the network capability component 1530 may be configured as or otherwise support a means for outputting the indication of the second set of one or more machine learning models via a registration response message.

In some examples, to support obtaining the indication of the first set of one or more machine learning models, the UE capability component 1525 may be configured as or otherwise support a means for obtaining a session establishment message or a modification request message indicating the first set of one or more machine learning models supported at the UE. In some examples, to support obtaining the indication of the first set of one or more machine learning models, the network capability component 1530 may be configured as or otherwise support a means for outputting the indication of the second set of one or more machine learning models via a session establishment response message or a modification response message.

In some examples, the first core network entity is an AMF entity. In some examples, the network entity communication component 1550 may be configured as or otherwise support a means for outputting the indication of the first set of one or more machine learning models supported at the UE to an SMF entity, where the second core network entity is the SMF entity. In some examples, the network entity communication component 1550 may be configured as or otherwise support a means for obtaining, from the SMF entity, the indication of the second set of one or more machine learning models supported at the SMF entity. In some examples, the network entity communication component 1550 may be configured as or otherwise support a means for obtaining, from the SMF entity, the control signaling indicating the configuration for the machine learning model.

In some examples, the first core network entity is an SMF entity. In some examples, the network entity communication component 1550 may be configured as or otherwise support a means for obtaining the indication of the first set of one or more machine learning models supported at the UE from an AMF entity, where the second core network entity is the AMF entity. In some examples, the network entity communication component 1550 may be configured as or otherwise support a means for outputting, to the AMF entity, the indication of the second set of one or more machine learning models supported at the SMF entity. In some examples, the network entity communication component 1550 may be configured as or otherwise support a means for outputting, to the AMF entity, the control signaling indicating the configuration for the machine learning model.

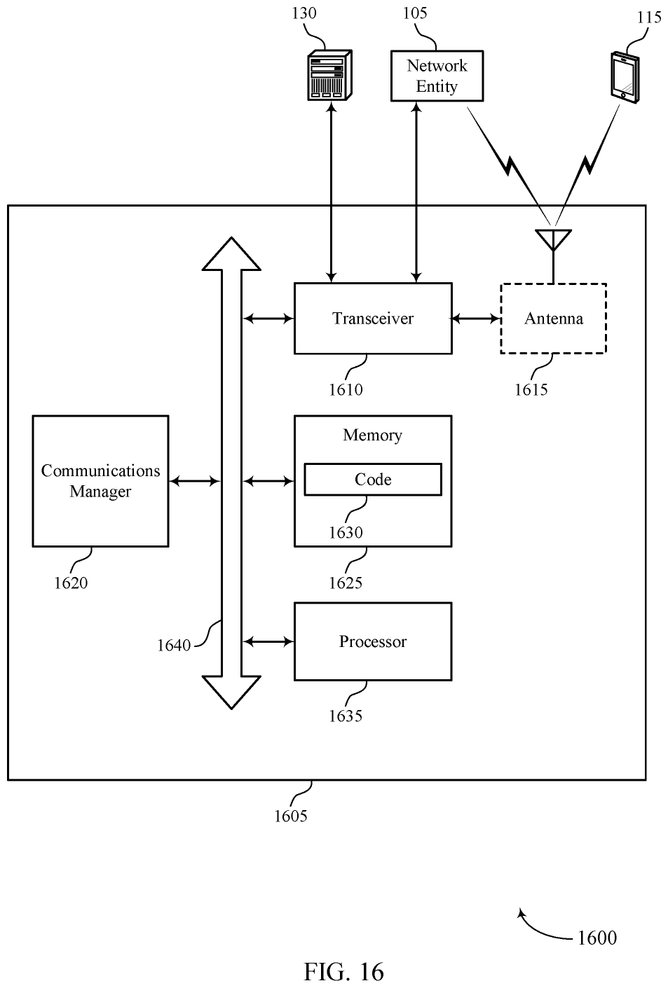

FIG. 16 shows a diagram of a system 1600 including a device 1605 that supports distributed machine learning model configurations in accordance with one or more aspects of the present disclosure. The device 1605 may be an example of or include the components of a device 1305, a device 1405, or a network entity 105 as described herein. The device 1605 may communicate with one or more network entities 105, one or more UEs 115, or any combination thereof, which may include communications over one or more wired interfaces, over one or more wireless interfaces, or any combination thereof. The device 1605 may include components that support outputting and obtaining communications, such as a communications manager 1620, a transceiver 1610, an antenna 1615, a memory 1625, code 1630, and a processor 1635. These components may be in electronic communication or otherwise coupled (e.g., operatively, communicatively, functionally, electronically, electrically) via one or more buses (e.g., a bus 1640).

The transceiver 1610 may support bi-directional communications via wired links, wireless links, or both as described herein. In some examples, the transceiver 1610 may include a wired transceiver and may communicate bi-directionally with another wired transceiver. Additionally, or alternatively, in some examples, the transceiver 1610 may include a wireless transceiver and may communicate bi-directionally with another wireless transceiver. In some examples, the device 1605 may include one or more antennas 1615, which may be capable of transmitting or receiving wireless transmissions (e.g., concurrently). The transceiver 1610 may also include a modem to modulate signals, to provide the modulated signals for transmission (e.g., by one or more antennas 1615, by a wired transmitter), to receive modulated signals (e.g., from one or more antennas 1615, from a wired receiver), and to demodulate signals. The transceiver 1610, or the transceiver 1610 and one or more antennas 1615 or wired interfaces, where applicable, may be an example of a transmitter 1315, a transmitter 1415, a receiver 1310, a receiver 1410, or any combination thereof or component thereof, as described herein. In some examples, the transceiver may be operable to support communications via one or more communications links (e.g., a communication link 125, a backhaul communication link 120, a midhaul communication link 162, a fronthaul communication link 168).

The memory 1625 may include RAM and ROM. The memory 1625 may store computer-readable, computer-executable code 1630 including instructions that, when executed by the processor 1635, cause the device 1605 to perform various functions described herein. The code 1630 may be stored in a non-transitory computer-readable medium such as system memory or another type of memory. In some cases, the code 1630 may not be directly executable by the processor 1635 but may cause a computer (e.g., when compiled and executed) to perform functions described herein. In some cases, the memory 1625 may contain, among other things, a BIOS which may control basic hardware or software operation such as the interaction with peripheral components or devices.

The processor 1635 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1635 may be configured to operate a memory array using a memory controller. In some other cases, a memory controller may be integrated into the processor 1635. The processor 1635 may be configured to execute computer-readable instructions stored in a memory (e.g., the memory 1625) to cause the device 1605 to perform various functions (e.g., functions or tasks supporting distributed machine learning model configurations). For example, the device 1605 or a component of the device 1605 may include a processor 1635 and memory 1625 coupled with the processor 1635, the processor 1635 and memory 1625 configured to perform various functions described herein. The processor 1635 may be an example of a cloud-computing platform (e.g., one or more physical nodes and supporting software such as operating systems, virtual machines, or container instances) that may host the functions (e.g., by executing code 1630) to perform the functions of the device 1605.

In some examples, a bus 1640 may support communications of (e.g., within) a protocol layer of a protocol stack. In some examples, a bus 1640 may support communications associated with a logical channel of a protocol stack (e.g., between protocol layers of a protocol stack), which may include communications performed within a component of the device 1605, or between different components of the device 1605 that may be co-located or located in different locations (e.g., where the device 1605 may refer to a system in which one or more of the communications manager 1620, the transceiver 1610, the memory 1625, the code 1630, and the processor 1635 may be located in one of the different components or divided between different components).

In some examples, the communications manager 1620 may manage aspects of communications with a core network 130 (e.g., via one or more wired or wireless backhaul links). For example, the communications manager 1620 may manage the transfer of data communications for client devices, such as one or more UEs 115. In some examples, the communications manager 1620 may manage communications with other network entities 105, and may include a controller or scheduler for controlling communications with UEs 115 in cooperation with other network entities 105. In some examples, the communications manager 1620 may support an X2 interface within an LTE/LTE-A wireless communications network technology to provide communication between network entities 105.

The communications manager 1620 may support wireless communications at a first core network entity in accordance with examples as disclosed herein. For example, the communications manager 1620 may be configured as or otherwise support a means for obtaining an indication of a first set of one or more machine learning models supported at a UE. The communications manager 1620 may be configured as or otherwise support a means for outputting an indication of a second set of one or more machine learning models supported at the first core network entity or a second core network entity, or both. The communications manager 1620 may be configured as or otherwise support a means for outputting control signaling indicating a configuration for a machine learning model, the first set of one or more machine learning model including the machine learning model.

By including or configuring the communications manager 1620 in accordance with examples as described herein, the device 1605 may support techniques for improved coordination between devices by identifying optimizations at a UE 115 or a core network, or both, based on the UE 115 performing inferences using a machine learning model. For example, an application client may request for the UE 115 to perform analytics using a machine learning model, and the UE 115 may report analytics information from the machine learning model. The application client may use the reported information for, for example, split rendering, reducing processing power at the UE 115 or network, or both.

In some examples, the communications manager 1620 may be configured to perform various operations (e.g., receiving, obtaining, monitoring, outputting, transmitting) using or otherwise in cooperation with the transceiver 1610, the one or more antennas 1615 (e.g., where applicable), or any combination thereof Δlthough the communications manager 1620 is illustrated as a separate component, in some examples, one or more functions described with reference to the communications manager 1620 may be supported by or performed by the processor 1635, the memory 1625, the code 1630, the transceiver 1610, or any combination thereof. For example, the code 1630 may include instructions executable by the processor 1635 to cause the device 1605 to perform various aspects of distributed machine learning model configurations as described herein, or the processor 1635 and the memory 1625 may be otherwise configured to perform or support such operations.

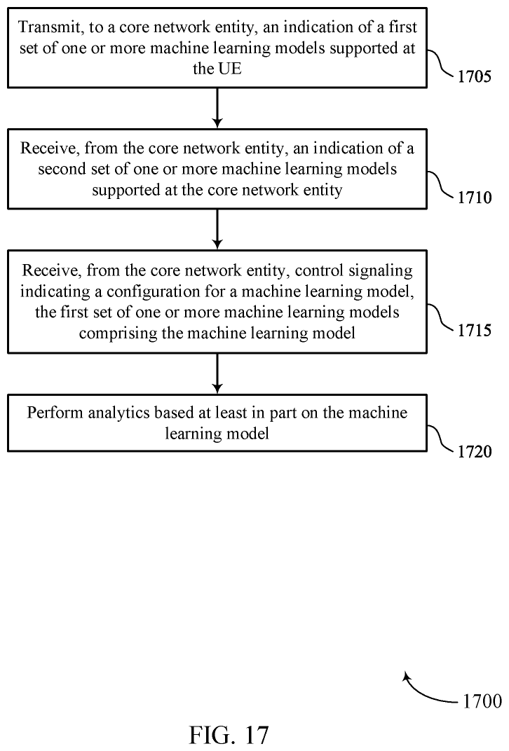

FIG. 17 shows a flowchart illustrating a method 1700 that supports distributed machine learning model configurations in accordance with one or more aspects of the present disclosure. The operations of the method 1700 may be implemented by a UE or its components as described herein. For example, the operations of the method 1700 may be performed by a UE 115 as described with reference to FIGS. 1 through 12. In some examples, a UE may execute a set of instructions to control the functional elements of the UE to perform the described functions. Additionally, or alternatively, the UE may perform aspects of the described functions using special-purpose hardware.

At 1705, the method may include transmitting, to a core network entity, an indication of a first set of one or more machine learning models supported at the UE. The operations of 1705 may be performed in accordance with examples as disclosed herein. In some examples, aspects of the operations of 1705 may be performed by a UE capability component 1125 as described with reference to FIG. 11.

At 1710, the method may include receiving, from the core network entity, an indication of a second set of one or more machine learning models supported at the core network entity. The operations of 1710 may be performed in accordance with examples as disclosed herein. In some examples, aspects of the operations of 1710 may be performed by a network capability component 1130 as described with reference to FIG. 11.

At 1715, the method may include receiving, from the core network entity, control signaling indicating a configuration for a machine learning model, the first set of one or more machine learning models including the machine learning model. The operations of 1715 may be performed in accordance with examples as disclosed herein. In some examples, aspects of the operations of 1715 may be performed by a machine learning model configuration component 1135 as described with reference to FIG. 11.

At 1720, the method may include performing analytics based on the machine learning model. The operations of 1720 may be performed in accordance with examples as disclosed herein. In some examples, aspects of the operations of 1720 may be performed by an analytics component 1140 as described with reference to FIG. 11.

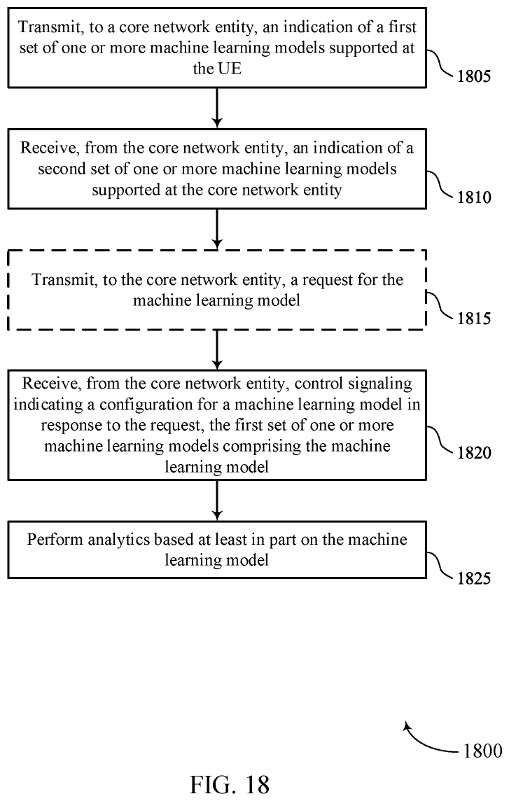

FIG. 18 shows a flowchart illustrating a method 1800 that supports distributed machine learning model configurations in accordance with one or more aspects of the present disclosure. The operations of the method 1800 may be implemented by a UE or its components as described herein. For example, the operations of the method 1800 may be performed by a UE 115 as described with reference to FIGS. 1 through 12. In some examples, a UE may execute a set of instructions to control the functional elements of the UE to perform the described functions. Additionally, or alternatively, the UE may perform aspects of the described functions using special-purpose hardware.

At 1805, the method may include transmitting, to a core network entity, an indication of a first set of one or more machine learning models supported at the UE. The operations of 1805 may be performed in accordance with examples as disclosed herein. In some examples, aspects of the operations of 1805 may be performed by a UE capability component 1125 as described with reference to FIG. 11.

At 1810, the method may include receiving, from the core network entity, an indication of a second set of one or more machine learning models supported at the core network entity. The operations of 1810 may be performed in accordance with examples as disclosed herein. In some examples, aspects of the operations of 1810 may be performed by a network capability component 1130 as described with reference to FIG. 11.

At 1815, the method may include transmitting, to the core network entity, a request for the machine learning model. The operations of 1815 may be performed in accordance with examples as disclosed herein. In some examples, aspects of the operations of 1815 may be performed by a request component 1145 as described with reference to FIG. 11.

At 1820, the method may include receiving, from the core network entity, control signaling indicating a configuration for a machine learning model in response to the request, the first set of one or more machine learning models including the machine learning model. The operations of 1820 may be performed in accordance with examples as disclosed herein. In some examples, aspects of the operations of 1820 may be performed by a machine learning model configuration component 1135 as described with reference to FIG. 11.

At 1825, the method may include performing analytics based on the machine learning model. The operations of 1825 may be performed in accordance with examples as disclosed herein. In some examples, aspects of the operations of 1825 may be performed by an analytics component 1140 as described with reference to FIG. 11.

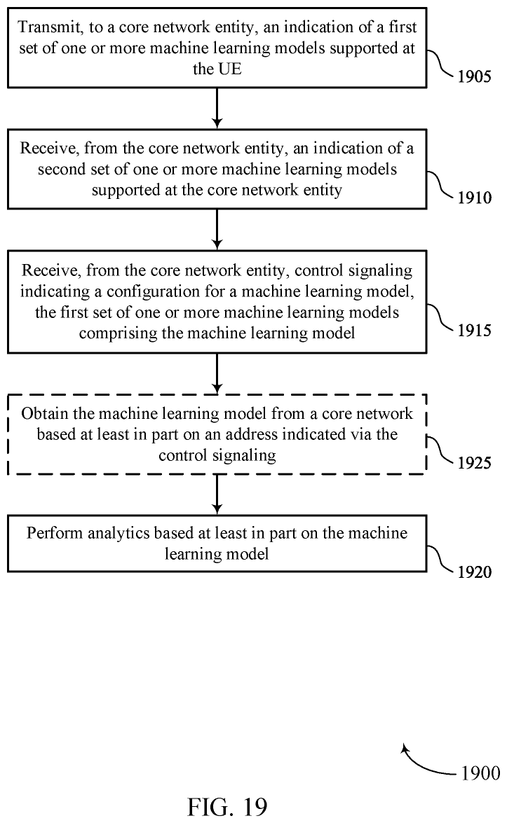

FIG. 19 shows a flowchart illustrating a method 1900 that supports distributed machine learning model configurations in accordance with one or more aspects of the present disclosure. The operations of the method 1900 may be implemented by a UE or its components as described herein. For example, the operations of the method 1900 may be performed by a UE 115 as described with reference to FIGS. 1 through 12. In some examples, a UE may execute a set of instructions to control the functional elements of the UE to perform the described functions. Additionally, or alternatively, the UE may perform aspects of the described functions using special-purpose hardware.

At 1905, the method may include transmitting, to a core network entity, an indication of a first set of one or more machine learning models supported at the UE. The operations of 1905 may be performed in accordance with examples as disclosed herein. In some examples, aspects of the operations of 1905 may be performed by a UE capability component 1125 as described with reference to FIG. 11.

At 1910, the method may include receiving, from the core network entity, an indication of a second set of one or more machine learning models supported at the core network entity. The operations of 1910 may be performed in accordance with examples as disclosed herein. In some examples, aspects of the operations of 1910 may be performed by a network capability component 1130 as described with reference to FIG. 11.

At 1915, the method may include receiving, from the core network entity, control signaling indicating a configuration for a machine learning model, the first set of one or more machine learning models including the machine learning model. The operations of 1915 may be performed in accordance with examples as disclosed herein. In some examples, aspects of the operations of 1915 may be performed by a machine learning model configuration component 1135 as described with reference to FIG. 11.

At 1920, the method may include obtaining the machine learning model from a core network based on an address indicated via the control signaling. The operations of 1920 may be performed in accordance with examples as disclosed herein. In some examples, aspects of the operations of 1920 may be performed by a machine learning model obtaining component 1155 as described with reference to FIG. 11.

At 1925, the method may include performing analytics based on the machine learning model. The operations of 1925 may be performed in accordance with examples as disclosed herein. In some examples, aspects of the operations of 1925 may be performed by an analytics component 1140 as described with reference to FIG. 11.

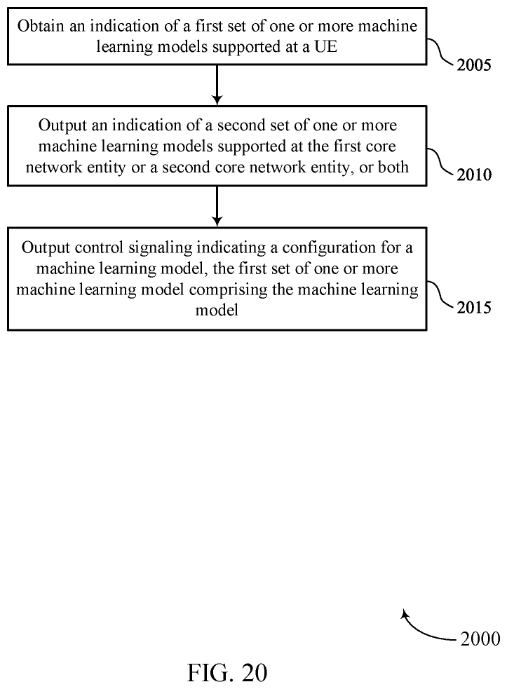

FIG. 20 shows a flowchart illustrating a method 2000 that supports distributed machine learning model configurations in accordance with one or more aspects of the present disclosure. The operations of the method 2000 may be implemented by a network entity or its components as described herein. For example, the operations of the method 2000 may be performed by a network entity as described with reference to FIGS. 1 through 8 and 13 through 16. In some examples, a network entity may execute a set of instructions to control the functional elements of the network entity to perform the described functions. Additionally, or alternatively, the network entity may perform aspects of the described functions using special-purpose hardware.

At 2005, the method may include obtaining an indication of a first set of one or more machine learning models supported at a UE. The operations of 2005 may be performed in accordance with examples as disclosed herein. In some examples, aspects of the operations of 2005 may be performed by a UE capability component 1525 as described with reference to FIG. 15.

At 2010, the method may include outputting an indication of a second set of one or more machine learning models supported at the first core network entity or a second core network entity, or both. The operations of 2010 may be performed in accordance with examples as disclosed herein. In some examples, aspects of the operations of 2010 may be performed by a network capability component 1530 as described with reference to FIG. 15.

At 2015, the method may include outputting control signaling indicating a configuration for a machine learning model, the first set of one or more machine learning model including the machine learning model. The operations of 2015 may be performed in accordance with examples as disclosed herein. In some examples, aspects of the operations of 2015 may be performed by a machine learning model configuring component 1535 as described with reference to FIG. 15.

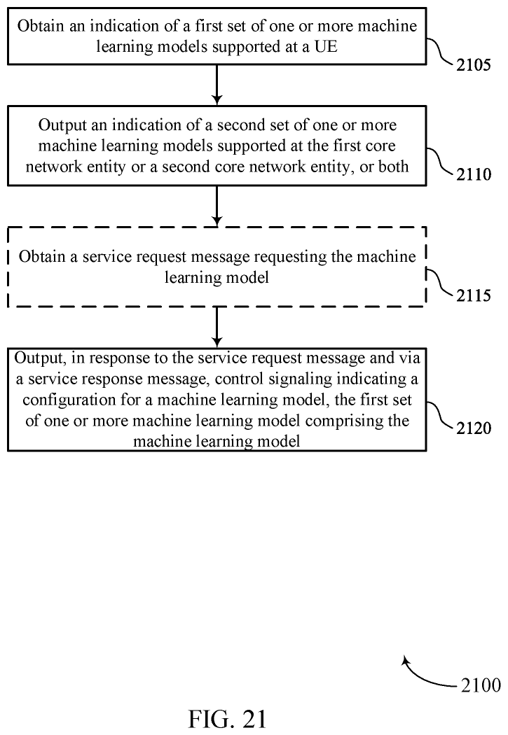

FIG. 21 shows a flowchart illustrating a method 2100 that supports distributed machine learning model configurations in accordance with one or more aspects of the present disclosure. The operations of the method 2100 may be implemented by a network entity or its components as described herein. For example, the operations of the method 2100 may be performed by a network entity as described with reference to FIGS. 1 through 8 and 13 through 16. In some examples, a network entity may execute a set of instructions to control the functional elements of the network entity to perform the described functions. Additionally, or alternatively, the network entity may perform aspects of the described functions using special-purpose hardware.

At 2105, the method may include obtaining an indication of a first set of one or more machine learning models supported at a UE. The operations of 2105 may be performed in accordance with examples as disclosed herein. In some examples, aspects of the operations of 2105 may be performed by a UE capability component 1525 as described with reference to FIG. 15.

At 2110, the method may include outputting an indication of a second set of one or more machine learning models supported at the first core network entity or a second core network entity, or both. The operations of 2110 may be performed in accordance with examples as disclosed herein. In some examples, aspects of the operations of 2110 may be performed by a network capability component 1530 as described with reference to FIG. 15.

At 2115, the method may include obtaining a service request message requesting the machine learning model. The operations of 2115 may be performed in accordance with examples as disclosed herein. In some examples, aspects of the operations of 2115 may be performed by a request receiving component 1540 as described with reference to FIG. 15.

At 2120, the method may include outputting, in response to the service request message and via a service response message, control signaling indicating a configuration for a machine learning model, the first set of one or more machine learning model including the machine learning model. The operations of 2120 may be performed in accordance with examples as disclosed herein. In some examples, aspects of the operations of 2120 may be performed by a machine learning model configuring component 1535 as described with reference to FIG. 15.

The following provides an overview of aspects of the present disclosure:

Aspect 1: A method for wireless communications at a UE, comprising: transmitting, to a core network entity, an indication of a first set of one or more machine learning models supported at the UE; receiving, from the core network entity, an indication of a second set of one or more machine learning models supported at the core network entity; receiving, from the core network entity, control signaling indicating a configuration for a machine learning model, the first set of one or more machine learning models comprising the machine learning model; and performing analytics based at least in part on the machine learning model.

Aspect 2: The method of aspect 1, further comprising: transmitting, to the core network entity, a request for the machine learning model; and wherein receiving the control signaling comprises: receiving the control signaling in response to transmitting the request.

Aspect 3: The method of aspect 2, wherein transmitting the request comprises: transmitting a service request message; and wherein receiving the control signaling comprises: receiving the control signaling via a service response message.

Aspect 4: The method of any of aspects 2 through 3, wherein transmitting the request comprises: transmitting a protocol data unit session modification request message; and wherein receiving the control signaling comprises: receiving the control signaling via a protocol data unit session modification command message.

Aspect 5: The method of any of aspects 2 through 4, wherein the request comprises an identifier for the machine learning model.

Aspect 6: The method of any of aspects 1 through 5, further comprising: transmitting, to the core network entity, a completion message based at least in part on the control signaling indicating the configuration for the machine learning model.

Aspect 7: The method of any of aspects 1 through 6, wherein receiving the control signaling comprises: receiving the control signaling indicating the configuration for the machine learning model, the control signaling indicating a machine learning model file address, a machine learning model training request, a machine learning model inference request, a machine learning model identifier, a machine learning model location, a machine learning model version, a duration of time for performing the analytics, an activation event for reporting the analytics, or any combination thereof.

Aspect 8: The method of any of aspects 1 through 7, wherein receiving the control signaling comprises: receiving a UE configuration update command indicating the configuration for the machine learning model.

Aspect 9: The method of any of aspects 1 through 8, wherein transmitting the indication of the first set of one or more machine learning models comprises: transmitting a registration request indicating the first set of one or more machine learning models supported at the UE; and wherein receiving the indication of the second set of one or more machine learning models comprises: receiving the indication of the second set of one or more machine learning models via a registration response message.

Aspect 10: The method of any of aspects 1 through 9, wherein receiving the control signaling comprises: receiving a protocol data unit session modification command indicating the configuration for the machine learning model.

Aspect 11: The method of aspect 10, further comprising: transmitting, to the core network entity, a protocol data unit session modification complete message based at least in part on the protocol data unit session modification command indicating the configuration for the machine learning model.

Aspect 12: The method of any of aspects 1 through 11, wherein transmitting the indication of the first set of one or more machine learning models comprises: transmitting a session establishment message or a modification request message indicating the first set of one or more machine learning models supported at the UE; and wherein receiving the indication of the second set of one or more machine learning models comprises: receiving the indication of the second set of one or more machine learning models via a session establishment response message or a modification response message.

Aspect 13: The method of any of aspects 1 through 12, wherein receiving the control signaling comprises: receiving one or more parameters for the machine learning model; and wherein performing the analytics comprises: performing the analytics based at least in part on the one or more parameters.

Aspect 14: The method of any of aspects 1 through 13, further comprising: obtaining the machine learning model from a core network based at least in part on an address indicated via the control signaling.

Aspect 15: The method of any of aspects 1 through 14, wherein the core network entity is an access and mobility management function (AMF) entity or a session management function (SMF) entity.

Aspect 16: A method for wireless communications at a first core network entity, comprising: obtaining an indication of a first set of one or more machine learning models supported at a UE; outputting an indication of a second set of one or more machine learning models supported at the first core network entity or a second core network entity, or both; and outputting control signaling indicating a configuration for a machine learning model, the first set of one or more machine learning model comprising the machine learning model.

Aspect 17: The method of aspect 16, further comprising: obtaining a service request message requesting the machine learning model; and wherein outputting the control signaling comprises: outputting the control signaling in response to the service request message via a service response message.

Aspect 18: The method of any of aspects 16 through 17, further comprising: obtaining a protocol data unit session modification request message requesting the machine learning model; and wherein outputting the control signaling comprises: outputting the control signaling via a protocol data unit session modification command message in response to the protocol data unit session modification request message.

Aspect 19: The method of any of aspects 16 through 18, further comprising: obtaining a UE configuration update complete message in response to the control signaling indicating the configuration for the machine learning model; and wherein outputting the control signaling comprises: outputting the control signaling via a UE configuration update command.

Aspect 20: The method of any of aspects 16 through 19, further comprising: obtaining a protocol data unit session modification complete message in response to the control signaling indicating the configuration for the machine learning model; and wherein outputting the control signaling comprises: outputting the control signaling via a protocol data unit session modification command message.

Aspect 21: The method of any of aspects 16 through 20, further comprising: obtaining, from another core network entity, a request for the UE to perform analytics based at least in part on the machine learning model; and wherein outputting the control signaling comprises: outputting the control signaling in response to the request.

Aspect 22: The method of any of aspects 16 through 21, wherein outputting the control signaling comprises: outputting the control signaling the configuration for the machine learning model, the control signaling indicating a machine learning model file address, a machine learning model training request, a machine learning model inference request, a machine learning model identifier, a machine learning model location, a machine learning model version, a duration of time for performing analytics according to the machine learning model, an activation event for reporting the analytics, one or more parameters for performing the analytics, or any combination thereof.

Aspect 23: The method of any of aspects 16 through 22, wherein outputting the indication of the first set of one or more machine learning models comprises: obtaining a registration request indicating the first set of one or more machine learning models supported at the UE; and wherein outputting the indication of the second set of one or more machine learning models comprises: outputting the indication of the second set of one or more machine learning models via a registration response message.

Aspect 24: The method of any of aspects 16 through 23, wherein obtaining the indication of the first set of one or more machine learning models comprises: obtaining a session establishment message or a modification request message indicating the first set of one or more machine learning models supported at the UE; and wherein outputting the indication of the second set of one or more machine learning models comprises: outputting the indication of the second set of one or more machine learning models via a session establishment response message or a modification response message.

Aspect 25: The method of any of aspects 16 through 24, wherein the first core network entity is an access and mobility management function (AMF) entity.

Aspect 26: The method of aspect 25, further comprising: outputting the indication of the first set of one or more machine learning models supported at the UE to a session management function (SMF) entity, wherein the second core network entity is the SMF entity; obtaining, from the SMF entity, the indication of the second set of one or more machine learning models supported at the SMF entity; and obtaining, from the SMF entity, the control signaling indicating the configuration for the machine learning model.

Aspect 27: The method of any of aspects 16 through 26, wherein the first core network entity is a session management function (SMF) entity.

Aspect 28: The method of aspect 27, further comprising: obtaining the indication of the first set of one or more machine learning models supported at the UE from an access and mobility management function (AMF) entity, wherein the second core network entity is the AMF entity; outputting, to the AMF entity, the indication of the second set of one or more machine learning models supported at the SMF entity; and outputting, to the AMF entity, the control signaling indicating the configuration for the machine learning model.

Aspect 29: An apparatus for wireless communications at a UE, comprising a processor; and memory coupled to the processor, the processor configured to perform a method of any of aspects 1 through 15.

Aspect 30: An apparatus for wireless communications at a UE, comprising at least one means for performing a method of any of aspects 1 through 15.

Aspect 31: A non-transitory computer-readable medium storing code for wireless communications at a UE, the code comprising instructions executable by a processor to perform a method of any of aspects 1 through 15.

Aspect 32: An apparatus for wireless communications at a first core network entity, comprising a processor; and memory coupled to the processor, the processor configured to perform a method of any of aspects 16 through 28.

Aspect 33: An apparatus for wireless communications at a first core network entity, comprising at least one means for performing a method of any of aspects 16 through 28.

Aspect 34: A non-transitory computer-readable medium storing code for wireless communications at a first core network entity, the code comprising instructions executable by a processor to perform a method of any of aspects 16 through 28.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a wide variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communications at a user equipment (UE), comprising:
a processor; and
memory coupled to the processor, the processor configured to:
transmit, to a core network entity, an indication of a first set of one or more machine learning models supported at the UE;
receive, from the core network entity, an indication of a second set of one or more machine learning models supported at the core network entity;
receive, from the core network entity, control signaling indicating a configuration for a machine learning model, the first set of one or more machine learning models comprising the machine learning model; and
perform analytics based at least in part on the machine learning model.

2. The apparatus of claim 1, wherein the processor is further configured to:
transmit, to the core network entity, a request for the machine learning model; and wherein, to receive the control signaling, the processor is further configured to:
receive the control signaling in response to transmitting the request.

3. The apparatus of claim 2, wherein, to transmit the request, the processor is configured to:
transmit a service request message; and wherein, to receive the control signaling, the processor is further configured to:
receive the control signaling via a service response message.

4. The apparatus of claim 2, wherein, to transmit the request, the processor is configured to:
transmit a protocol data unit session modification request message; and wherein, to receive the control signaling, the processor is further configured to:
receive the control signaling via a protocol data unit session modification command message.

5. The apparatus of claim 2, the request comprising an identifier for the machine learning model.

6. The apparatus of claim 1, wherein the processor is further configured to:
transmit, to the core network entity, a completion message based at least in part on the control signaling indicating the configuration for the machine learning model.

7. The apparatus of claim 1, wherein, to receive the control signaling, the processor is configured to:
receive the control signaling indicating the configuration for the machine learning model, the control signaling indicating a machine learning model file address, a machine learning model training request, a machine learning model inference request, a machine learning model identifier, a machine learning model location, a machine learning model version, a duration of time for performing the analytics, an activation event for reporting the analytics, or any combination thereof.

8. The apparatus of claim 1, wherein, to receive the control signaling, the processor is configured to:
receive a UE configuration update command indicating the configuration for the machine learning model.

9. The apparatus of claim 1, wherein, to transmit, the processor and is configured to:
transmit a registration request indicating the first set of one or more machine learning models supported at the UE; and wherein, to receive the indication of the second set of one or more machine learning models, the processor is configured to:
receive a registration response message indicating the second set of one or more machine learning models.

10. The apparatus of claim 1, wherein, to receive the control signaling, the processor is configured to:
receive a protocol data unit session modification command indicating the configuration for the machine learning model.

11. The apparatus of claim 10, wherein the processor is further configured to:
transmit, to the core network entity, a protocol data unit session modification complete message based at least in part on the protocol data unit session modification command indicating the configuration for the machine learning model.

12. The apparatus of claim 1, wherein the processor is further configured to:
transmit a session establishment message or a modification request message indicating the first set of one or more machine learning models supported at the UE; and, wherein to receive the indication of the second set of one or more machine learning models, the processor is configured to:
receive the indication of the second set of one or more machine learning models via a session establishment response message or a modification response message.

13. The apparatus of claim 1, wherein, to receive the control signaling, the processor is configured to:
receive one or more parameters for the machine learning model; and wherein, to perform the analytics, the processor is configured to:
perform the analytics based at least in part on the one or more parameters.

14. The apparatus of claim 1, wherein the processor is further configured to:
receive the machine learning model from a core network based at least in part on an address indicated via the control signaling.

15. The apparatus of claim 1, wherein the core network entity is an access and mobility management function (AMF) entity or a session management function (SMF) entity.

16. An apparatus for wireless communications at a first core network entity, comprising:
a processor; and
memory coupled to the processor, the processor configured to:
obtain an indication of a first set of one or more machine learning models supported at a user equipment (UE);
output an indication of a second set of one or more machine learning models supported at the first core network entity or a second core network entity, or both; and
output control signaling indicating a configuration for a machine learning model at the UE, the first set of one or more machine learning models comprising the machine learning model.

17. The apparatus of claim 16, wherein the processor is further configured to:
obtain a service request message requesting the machine learning model; and wherein, to output the control signaling, the processor is configured to:
output the control signaling via a service response message in response to the service request message.

18. The apparatus of claim 16, wherein the processor is further configured to:
obtain a protocol data unit session modification request message requesting the machine learning model; and where, to output the control signaling, the processor is configured to:
output the control signaling via a protocol data unit session modification command message in response to the protocol data unit session modification request message.

19. The apparatus of claim 16, wherein the processor is further configured to:
obtain a UE configuration update complete message in response to the control signaling indicating the configuration for the machine learning model; and wherein, to output the control signaling, the processor is further configured to:
output the control signaling via a UE configuration update command.

20. The apparatus of claim 16, wherein the processor is further configured to:
obtain a protocol data unit session modification complete message in response to the control signaling indicating the configuration for the machine learning model; and wherein, to output the control signaling, the processor is configured to:
output the control signaling via a protocol data unit session modification command message.

21. The apparatus of claim 16, wherein the processor is further configured to:
obtain, from another core network entity, a request for the UE to perform analytics based at least in part on the machine learning model; and, wherein to output the control signaling, the processor is configured to:
output the control signaling in response to the request.

22. The apparatus of claim 16, wherein, to output the control signaling, the processor is configured to:
output the control signaling indicating the configuration for the machine learning model at the UE, the control signaling indicating a machine learning model file address, a machine learning model training request, a machine learning model inference request, a machine learning model identifier, a machine learning model location, a machine learning model version, a duration of time for performing analytics according to the machine learning model, an activation event for reporting the analytics, one or more parameters for performing the analytics, or any combination thereof.

23. The apparatus of claim 16, wherein, to obtain the indication, the processor is configured to:
obtain a registration request indicating the first set of one or more machine learning models supported at the UE, wherein, to output the indication of the second set of one or more machine learning models, the processor is configured to:
output the indication of the second set of one or more machine learning models via a registration response message.

24. The apparatus of claim 16, wherein, to obtain the indication, the processor is configured to:
obtain a session establishment message or a modification request message indicating the first set of one or more machine learning models supported at the UE; and wherein, to output the indication of the second set of one or more machine learning models, the processor is configured to:
output the indication of the second set of one or more machine learning models via a session establishment response message or a modification response message.

25. The apparatus of claim 16, wherein the first core network entity is an access and mobility management function (AMF) entity.

26. The apparatus of claim 25, wherein the processor is further configured to:
output the indication of the first set of one or more machine learning models supported at the UE to a session management function (SMF) entity, wherein the second core network entity is the SMF entity;
obtain, from the SMF entity, the indication of the second set of one or more machine learning models supported at the SMF entity; and
obtain, from the SMF entity, the control signaling indicating the configuration for the machine learning model.

27. The apparatus of claim 16, wherein the first core network entity is a session management function (SMF) entity.

28. The apparatus of claim 27, wherein the processor is further configured to:
obtain the indication of the first set of one or more machine learning models supported at the UE from an access and mobility management function (AMF) entity, wherein the second core network entity is the AMF entity;
output, to the AMF entity, the indication of the second set of one or more machine learning models supported at the SMF entity; and
output, to the AMF entity, the control signaling indicating the configuration for the machine learning model at the UE.

29. A method for wireless communications at a user equipment (UE), comprising:
transmitting, to a core network entity, an indication of a first set of one or more machine learning models supported at the UE;
receiving, from the core network entity, an indication of a second set of one or more machine learning models supported at the core network entity;
receiving, from the core network entity, control signaling indicating a configuration for a machine learning model, the first set of one or more machine learning models comprising the machine learning model; and
performing analytics based at least in part on the machine learning model.

30. A method for wireless communications at a first core network entity, comprising:
receiving, from a user equipment (UE), an indication of a first set of one or more machine learning models supported at the UE;
transmitting, to the UE, an indication of a second set of one or more machine learning models supported at the first core network entity or a second core network entity, or both; and
transmitting, to the UE, control signaling indicating a configuration for a machine learning model, the first set of one or more machine learning models comprising the machine learning model.
